(19) United States
(12) Patent Application Publication
(10) Pub. No.: US 2024/0345798 A1
(43) Pub. Date: Oct. 17, 2024

(54) Management of Media Playback System Splits and Location Designation for Partitions of a Media Playback System

(71) Applicant: SONOS, INC., Santa Barbara, CA (US)

(72) Inventors: Gregory P. RAMSPERGER, Portland, OR (US); Jillian GARBER, Issaquah, WA (US); Nikit WAGHELA, Jersey City, NJ (US)

(21) Appl. No.: 18/635,422

(22) Filed: Apr. 15, 2024

Related U.S. Application Data
(60) Provisional application No. 63/459,882, filed on Apr. 17, 2023.
(60) Provisional application No. 63/459,887, filed on Apr. 17, 2023.
(60) Provisional application No. 63/459,897, filed on Apr. 17, 2023.

(51) Int. Cl. G06F 3/16; G05B 19/418

(52) U.S. Cl. CPC G06F 3/165; G05B 19/418; G05B 2219/2642

(57) ABSTRACT

The disclosure relates to management of media playback system splits and location designation for partitions of a media playback system. Some techniques involve storing an association between a media playback system and a location identifier. When a split of the media playback system is detected, an indication of the split is provided via a user interface of the media playback system. Based on an input received via the user interface confirming the split, one or more of the partitions of the split can be dissociated from the location identifier and associated with a different location identifier.

### CROSS-REFERENCE TO RELATED APPLICATIONS

This application claims priority to U.S. Provisional Application No. 63/459,882, filed Apr. 17, 2023 and titled “Management of Media Playback System Splits and Location Designation for Partitions of a Media Playback System”, U.S. Provisional Application No. 63/459,887, filed Apr. 17, 2023 and titled “Multi-User Media Playback System”, and to U.S. Provisional Application No. 63/459,897, filed Apr. 17, 2023 and titled “Media Playback System Switcher”, the contents of each of which are incorporated by reference in their entireties.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 includes a set of diagrams that illustrate exemplary configurations of a media playback system topology, in accordance with embodiments described herein.

FIG. 3 includes flowcharts for a set of example methods that can be performed by a media playback system, in accordance with embodiments described herein.

FIG. 4 includes flowcharts for a set of example methods for creating a location, in accordance with embodiments described herein.

FIG. 5 includes flowcharts for a set of example methods for accessing a location, in accordance with embodiments described herein.

FIG. 6 includes flowcharts for a set of example methods for setting up playback devices of a media playback system with a location, in accordance with embodiments described herein.

FIG. 7 includes example scenarios in which two playback devices register with a computing system, in accordance with embodiments described herein.

FIG. 8 includes other example scenarios in which two playback devices register with the computing system, in accordance with embodiments described herein.

FIG. 9 includes flowcharts for a set of example methods of notifying a user and receiving user input, in accordance with embodiments described herein.

FIG. 10A includes an example of a data structure in the form of a table that could be used to represent nodes in the topology, in accordance with embodiments described herein.

FIG. 10B includes an example of a data structure in the form of a table that could be used to represent a mapping, in accordance with embodiments described herein.

FIG. 11 includes an example flowchart illustrating example processes in which the topology table and/or any related mappings can be accessed/updated, in accordance with embodiments described herein.

FIG. 12A includes an example media playback system topology comprising a location group, in accordance with embodiments described herein.

FIG. 12B includes additional examples of media playback system topologies comprising location groups, in accordance with embodiments described herein.

FIG. 12C includes additional examples of media playback system topologies comprising location groups, in accordance with embodiments described herein.

FIG. 12D includes additional examples of media playback system topologies comprising location groups, in accordance with embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. OVERVIEW

A media playback system according to some embodiments disclosed herein can comprise a number of playback devices registered under a same user or family of users (e.g., owner or administrator). In some instances, the playback devices can be connected to and communicate over a network such as a Local Area Network (LAN). The media playback system can be configured to create a secure domain based on the LAN to replicate settings and provide interoperability among devices. For example, devices on the same LAN can be discoverable by each other, exchange messages and/or commands, be addressed collectively, be grouped to playback media content in synchrony, among other functionalities.

In some instances, a media playback system can comprise (or be split into) two or more partitions (e.g., two or more sets or subsystems of one or more playback devices). A partition, as used herein, refers to a set of one or more playback devices that are connected to the same LAN. In this way, the media playback system can be said to be split when one or more playback devices are connected to a LAN different from the LAN(s) to which other playback devices in the media playback system are connected. This type of split can be referred to as a networking split. In some instances, when playback devices are in different partitions, they can be considered to be in different domains. In some instances, certain operations such as replication of particular settings, commands addressability, and/or grouping may be limited to playback devices on the same domain or partition of the split.

A networking split of a media playback system into two or more partitions could occur for various reasons. In some instances, the media playback system can be intentionally split. For example, one or more playback devices can be located at and/or relocated to a different physical location and/or purposely connected to a different LAN. In some other instances, however, the media playback system could be unintentionally split. For example, certain configuration or operational changes such as changes related to network connectivity could cause an unintentional split of the media playback system. Those changes can be inadvertently caused by a user action. For example, the user could install a new router in their house. In a scenario in which the user has not yet connected all the playback devices to the new router, the user could induce an unintentional media playback system spit because playback devices connected to the old router would be connected via a LAN different than playback devices connected to the new router, even though in theory all the playback devices are in the user home's domain.

Therefore, media playback system splits should be managed carefully to ensure that the overall user experience is not negatively impacted. For example, it can be important to ensure that playback devices that are intended to operate as a single partition/set of playback devices (e.g., in the same LAN and/or secure domain) are not inadvertently split into two or more partitions/subsets of playback devices. Embodiments described herein relate to, among other things, managing splits of media playback systems into two or more partitions to address some of those concerns.

Reconfiguring the media playback system automatically when a networking split of the media playback system is detected may not always be the solution that better fits the user intent. In some situations, assuming that a newly detected partition should be treated as an intentionally created partition and adjusting the system accordingly by treating each partition as an independent subsystem of playback devices may disrupt the expected behavior of the media playback system as a whole.

Referring back to the example of the user installing a new router, this situation could cause an unintentional system split between playback devices connected to the old router and playback devices connected to the new router. In this situation, the system could detect the networking split and infer, for example, that the playback devices are currently in separate physical locations and/or are part of an independent subsystem of playback devices. In this example, the user could be prevented from operating the media playback system with respect to some functionalities because a command to the media playback system could end up being received and therefore executed by only one partition of the split.

As a practical example of the above situation, the user may wish to start playback in all their devices throughout the house by issuing a command, for example via a hardware interface of a playback device, via a controller device, via a voice command, etc. The command may be routed to/through the LAN to which devices in one partition are connected, but not to/through the other. In this way, the command may be received and executed by playback devices in one partition of the split. However, playback devices connected to the other partition may not receive or execute the command. Therefore, the user experience may be disrupted as the system may not behave as the user intended. Furthermore, in many instances, users may not even be aware of the root of the problem and may not be able to solve it on their own.

As evidenced from the examples above, it could be advantageous to associate playback devices of a media playback system and/or its different partitions in a way that allows the user flexibility to move forward with any configuration (e.g., networking) changes and/or revert them without major impact on the system's operation. For example, it could be advantageous to associate playback devices of a media playback system and/or different partitions of the media playback system in a way that can persist and/or remain stable during configuration changes. In some instances, this stable association could facilitate abstracting certain configuration changes that occur in the front end of the media playback system (e.g., caused by the user either intentionally or unintentionally) from the back end (e.g., interoperability of the different devices in the system, integrations and/or interactions with remote computing systems such as streaming service providers and/or voice assistants, etc.). For example, this stable association could allow the user to make unintentional and/or intentional networking changes to their media playback system without major impact to the overall functioning of the media playback system as a whole. In some instances, this stable association comprises the use of locations.

Playback devices of a media playback system and/or its partitions can be associated with and/or assigned to locations to address one or more of the concerns described above. Therefore, some aspects of this disclosure relate to location designation for different partitions of a media playback system. A “location”, as used herein, refers to and/or identifies a collection of playback devices. The collection of playback devices can include one or more partitions and/or one or more sets/subsystems of playback devices. In some instances, a “location” refers to a collection of playback devices that are meant to be able to work together (e.g., as part of the same domain), regardless of the actual physical location where the devices are and/or the LAN to which the devices are connected. It should be understood that the term “location”, as used in this disclosure, does not indicate a particular place or position. To avoid confusion, the term “physical location” or “place” will be used, if necessary, to refer to a particular place or position.

Referring back to the previous example of the user installing a new router, before the networking split, the playback devices could have been associated and/or assigned to a “Home” location, in accordance with embodiments described herein. When the networking split is detected, all the playback devices (i.e., both partitions) would still be mapped to the “Home” location. Rather than automatically treating each partition as individual subsystems of playback devices, the system can notify the user to confirm whether the split was intentional/unintentional and/or whether the user intends to have the new partition dissociated from the “Home” location (e.g., to associate it with a different location). At this point, the user may become aware of the status of the system via the notification, and confirm that the split was unintentional because the user was simply changing routers. In the meantime, all playback devices would still be associated with the same location and any attributes (e.g., commands, settings, integrations, etc.) established for the location would apply to all the partitions so that there is minimal to no disruption to the user experience.

In the scenario described above, the system could wait until the networking split is solved (e.g., confirmed as intentional or unintentional) before taking any action that may affect the structure or operation of the system. For example, the system could wait until the user confirms how the detected networking split should be treated before implementing the split at a system level (e.g., altering the system's configuration, the system's structure, the system's topology, etc.). The system could optionally guide the user to arrange the system to the desired configuration. The user, now aware of the issue, could rearrange the system by connecting all playback devices to the same router or otherwise associating them to the same LAN, if so desired.

In some instances, the user could leave the two (or more) partitions under the same location so that the two partitions share a common set of attributes at the location level but can further be associated with attributes specific to the partition. In some instances, having two or more partitions under the same location can be considered a state that needs user resolution (e.g., temporary and/or conflict state). In some instances, the user could confirm the split as intentional and create/select a different location (e.g., “outdoors” or “vacation home”) for one of the partitions. In some instances, locations can be grouped in location groups. In this way, if it desired to associate multiple partitions/locations under a same topology node (e.g., so that they share a common set of attributes and/or can be addressed collectively), they can be associated via a location group. For example, the user could have an “indoors” and an “outdoors” location under a “home” location group.

Structurally, a “location” can be a node in a topology of the media playback system under which partitions (or any other type of node in the topology) of the media playback system comprising one or more playback devices can be established. In this way, every time a new location is established for a media playback system, a new node can be added to the topology. Sets of devices (e.g., partitions, other locations, etc.) and/or individual devices can be assigned to locations and vice-versa. In this way, partitions and/or devices can be under a location node in the topology. In some instances, attributes and settings applied to the location node apply to any node under the location (e.g., the partitions and/or devices).

At the implementation level, a “location” can be represented by a data object/structure to which a set of attributes and/or “children” nodes can be assigned. In some instances, the location can be represented by a data object with a stable identifier. The location and/or location identifier can be stable in that they remain unchanged in the presence of configuration changes detected in the system unless a user confirms the change (i.e., they do not automatically change due to configuration (e.g., networking) changes detected in the system). In some instances, the location can be represented by a data object with a permanent identifier. The location and/or location identifier can be permanent in that they persist even when there are no devices (e.g., no active devices, not connected devices, no devices assigned at all, etc.) associated with such location unless a user expressly deletes the location. In some instances, locations and/or location identifiers can be both stable and permanent so that they can only be changed and/or deleted upon user confirmation.

In some instances, even if the locations/location identifiers are stable and/or permanent, the location object may be subject to changes. For example, the location object may change over time to accommodate changes such as values to attributes, configurations settings, updates to the topology, etc. As a specific example, a location could be named and/or configured by a user. The name and/or configuration changes could be saved (e.g., as attributes and/or updates to the attributes) in association with the location object. In this case, the location object could change, and the location (as a topology node) and/or location identifier would remain stable and/or permanent.

Locations can be selected, created and/or caused to be created by a user. For example, when the user sets up their media playback system for the first time, the user may create/select a location (e.g., “Home”) to be associated with the media playback system. Any playback device that the user associates with such location can be part of a collection of playback devices (i.e., the given location) that share a common set of attributes (e.g., a location name, location identifier, certain settings, permissions, entitlements, subscriptions, etc.). In some instances, locations can be created by the system, for example for a playback device for which the location data is unknown or not provided. In those instances, the user could still be able to change the locations and/or its associated data (e.g., location name). In some instances, attributes and/or attribute values can be assigned to the locations. For example, locations can be named and/or configured by a user.

In some instances, when a split is detected for a set of playback devices associated with a given location, subsequent partitions of the split can be associated with the same location unless the user explicitly confirms that the partitions are to be treated as individual locations. In other words, partitions of a set of playback devices that is under a certain location node in the topology can be established under the same location node unless the user explicitly confirms that a new location node should be added to the topology. At the implementation level, this could result in one or more partitions or subsets of devices being added (e.g., associated) to the location, for example by mapping them to the location data object.

Another practical example to illustrate some of the benefits of the approaches described in this disclosure could include a business such as a “Restaurant A”. “Restaurant A” could include an “upstairs” and a “downstairs” area. In a scenario in which different routers are installed for the upstairs and the downstairs areas, the system could treat each of those areas as different partitions of the media playback system as the playback devices would generally be connected through different LANs. However, the administrator may decide to treat all the playback devices as part of the same “Restaurant A” location. In this case, even though a physical or networking split of the system has occurred in practice, each partition could be mapped to the same location so that both the upstairs partition and the downstairs partition can be addressed via the “Restaurant A” location. Alternatively, “upstairs” and a “downstairs” can be independent locations grouped under a “Restaurant A” location group. In this way, the Restaurant A can be addressed as a whole as well as any of its locations.

In the example above, the opposite situation could also be possible, in which the administrator may wish to create individual locations for the upstairs and downstairs partitions. In this case, the administrator could confirm the split, causing each partition to be associated to a different location. In some instances, the user may designate locations at will, even when no networking split exists, for example even if all the playback devices are in the same LAN.

Restaurant “A” could be member of a restaurant chain that owns a media playback system for the chain. The media playback system could include any number of locations such as “Restaurant A”, “Restaurant B”, “Restaurant C”, “Corporate”, etc. The different locations might not necessarily be associated with different physical locations. For example, location “Restaurant A” could be in the same physical location as “Corporate” (e.g., in the same building). Other example media playback systems that could use the described techniques are described in U.S. patent application Ser. No. 18/635,595, filed Apr. 15, 2024 and titled “MULTI-USER MEDIA PLAYBACK SYSTEM,” and U.S. patent application Ser. No. 18/635,943, filed Apr. 15, 2024 and titled “Media Playback System Switcher”, the contents of each of which are incorporated by reference in their entireties.

In any case, allowing partitions to be created and/or merged within a broader domain (i.e., the locations) allows the system to use the location as a targetable and/or addressable entity that can include all playback devices and/or partitions within such location. In this way, the system can address a location (for example to send commands and/or establish attributes such as settings, permissions, integrations, etc.) regardless of the underlaying changes at the LAN level. As explained before, when a split is detected, the system can notify the user while still mapping all partitions of the split to the same location. In this way, any attributes established at the locations level would still apply to all partitions of the split. Additionally, this approach could also enable continued addressing and/or targeting of all the partitions of the split and/or devices in such partitions (e.g., for command addressability), because their location and/or location identifier remains unchanged. In some instances, only after it is confirmed that the split was intentional and/or that the partitions are to be addressed as separate locations, the new partition can be mapped to a new location.

In some embodiments, for example, a computing system is disclosed. The computing system comprises at least one processor and at least one non-transitory computer-readable medium comprising program instructions that are executable by the at least one processor such that the computing system is configured to: store an association between a media playback system and a first location identifier, wherein the media playback system comprises at least a first playback device and a second playback device connected to a first local area network; detect a split of the media playback system into a first partition comprising at least the first playback device connected to the first local area network and a second partition comprising at least the second playback device connected to a second local area network; cause the media playback system to provide an indication of the split via a user interface of the media playback system; and based on an input received via the user interface confirming the split, dissociate the second partition from the first location identifier and associate it with a second location identifier.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

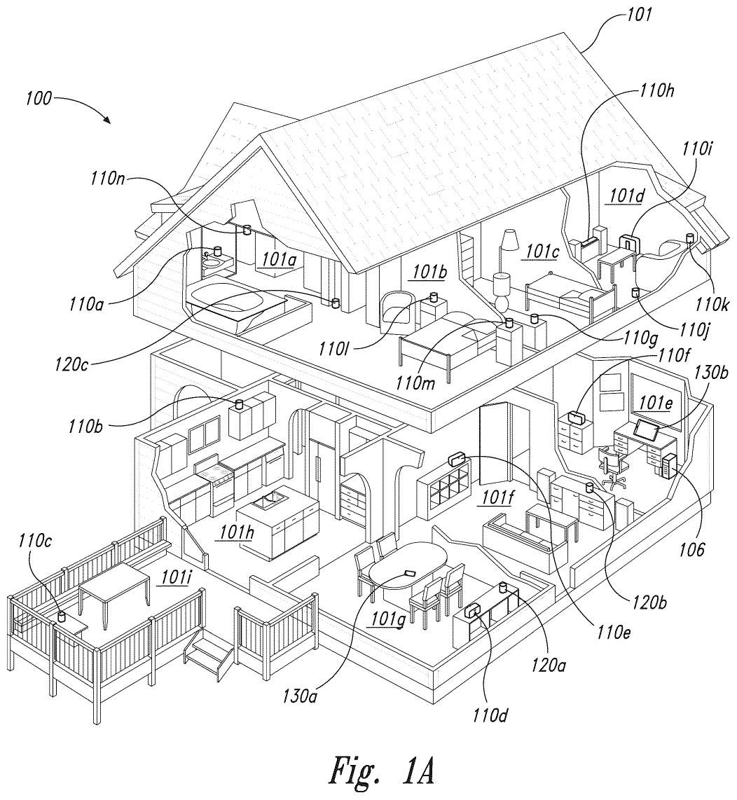

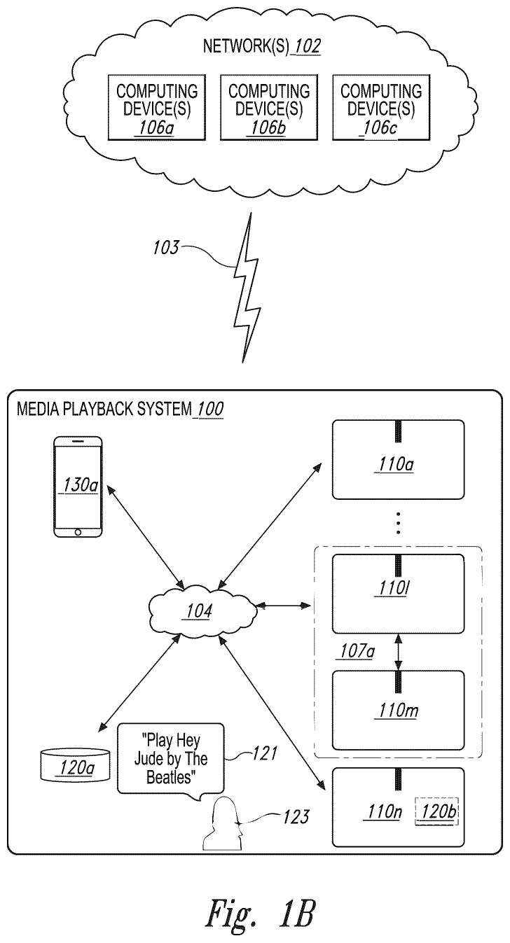

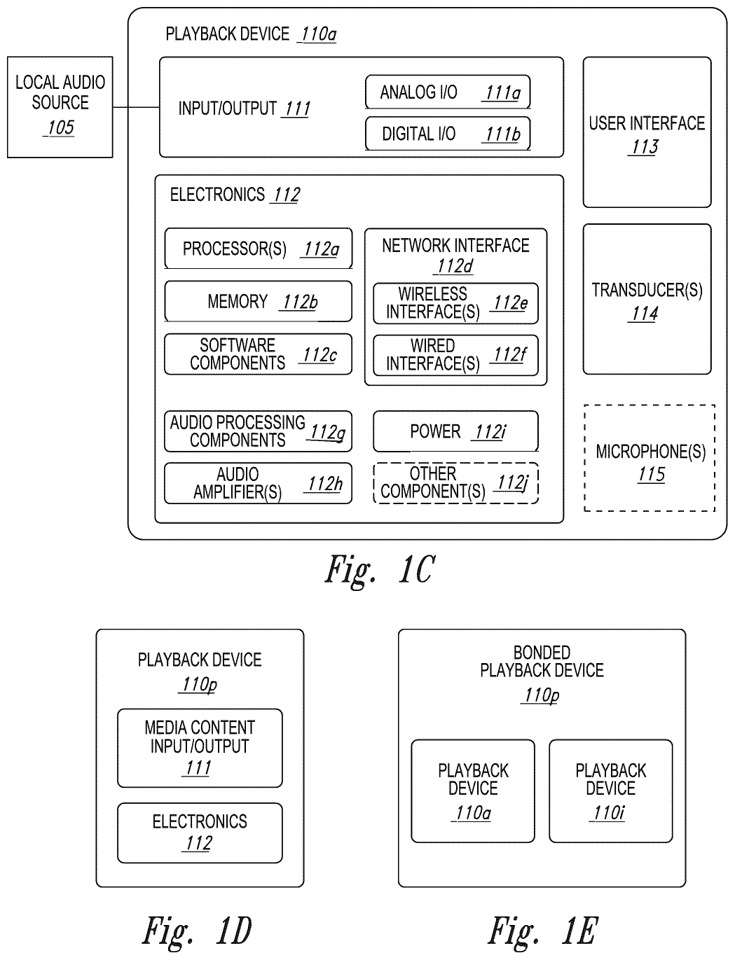

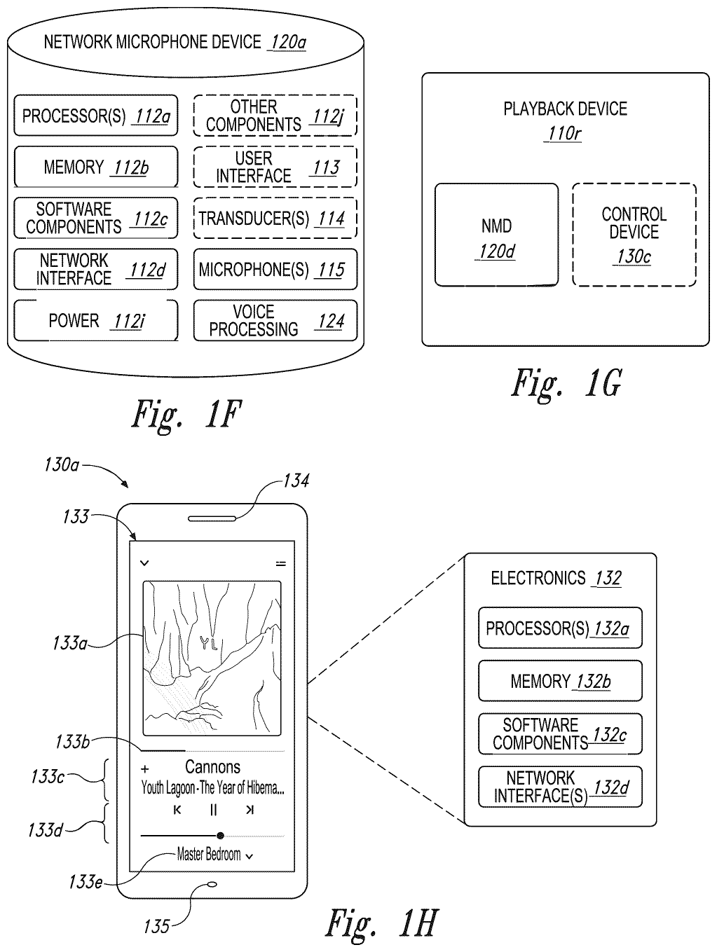

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. SUITABLE OPERATING ENVIRONMENT

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. MANAGEMENT OF MEDIA PLAYBACK SYSTEM SPLITS AND LOCATION DESIGNATION FOR PARTITIONS OF A MEDIA PLAYBACK SYSTEM

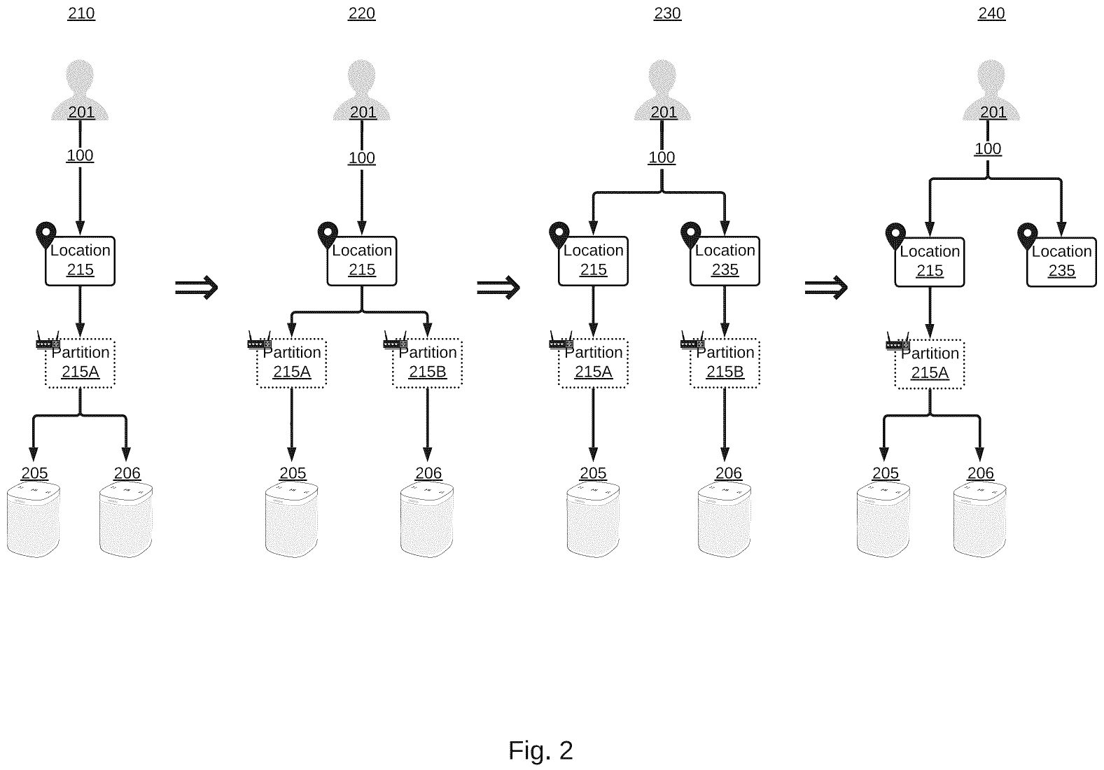

FIG. 2 includes a set of diagrams 210, 220, 230 and 240 that illustrate exemplary configurations of a media playback system topology comprising at least two playback devices 205 and 206, in accordance with embodiments described herein. The media playback system can be the same or similar to media playback system 100 described with reference to FIGS. 1A-1H and include any number of playback devices and other devices such as one or more control devices. The playback devices 205 and 206 can be the same or similar to the playback devices 110 described with reference to FIGS. 1A-1H. In addition, the media playback system can include and/or work in association with one or more networks such as network 102 and/or one or more computing devices such as computing devices 106, as also described with reference to FIGS. 1A-1H.

Diagram 210 illustrates an example of a media playback system 100 which is associated with (e.g., belongs to, is assigned to, is registered with, etc.) a user 201, such as an owner or system administrator. As will be described in more detail below, the media playback system can be associated with the user 201 during a set up process in which the media playback system and/or individual devices are configured/registered with a user account/credentials so that all the devices in the system are identified as belonging to/registered with the same user/user account. The user 201 can be any type of entity such as a person, a company, an organization, a business, etc.

Diagram 210 illustrates the playback devices 205 and 206 of the media playback system 100 as part of a single subsystem or partition 215A. As explained before in this disclosure, devices can be said to be in the same partition when they are connected to the same LAN. In some instances, the partition 215A can be an addressable partition so that it can be addressed and/or controlled directly. For example, the partition 215A can be a subsystem of playback devices with a respective subsystem identifier as described in U.S. Pat. No. 10,602,286, filed Jun. 25, 2018, entitled “Controlling Multi-Site Media Playback Systems”, which is incorporated herein by reference in its entirety.

Diagram 210 illustrates the playback devices 205 and 206 in partition 215A of the media playback system 100 associated with a location 215. As explained before in this disclosure and will be explained in more detail below, a location, such as location 215, refers to a collection of playback devices. A location can be independent of any physical parameters such as the physical location where the devices are at or the LAN to which the devices are connected. For example, “upstairs” and “downstairs” areas of the same restaurant can be considered two different locations if so desired by the user, even though the areas are in substantially the same physical location.

This collection of playback devices can be named (location name in this disclosure) by the user so that it is easier for the user to identify the collection of playback devices under such location name. For example, a user can name the location 215 “Home” and associate the playback devices 205/206 in their house with such location. A unique identifier (location identifier in this disclosure) can be system-generated for each location independent of the name that the user assigns to the location. For example, different users of different media playback systems can each have locations named “Home”. Such locations can be associated with a system-generated location identifier that is unique so that even if the locations have the same name to their respective users they can be identified unambiguously, for example by a remote computing system/cloud.

Locations can be addressable so that devices, systems, services, etc. can refer to a location using a location “address”. A location address can include, for example, location identifier or any other parameter(s) that serves to identify the location for addressability, such as the location name or other associated metadata. In this way, any device (e.g., remote computing systems/services such as media streaming service, a voice assistant service, etc.) can address the location (e.g., communicate with, send messages, commands, etc.). In some instances, playback devices associated under the same location can be addressed collectively by addressing the location. In some instances, attributes associated with the location and/or the location name/identifier can apply to the whole collection of playback devices under such location.

In some instances, a location refers to a collection of playback devices (e.g., a list of devices/device identifiers) that are associated with and/or share a common set of one or more attributes. Devices for which a given location is assigned and/or are otherwise associated with the given location can adopt any attributes of the given location. In the example of FIG. 2, for example, playback devices 205 and 206 can be both associated with an attribute that is common to location 215 and/or all devices associated with location 215. Non limiting examples of attributes will be given in the following paragraph and/or elsewhere in this disclosure. Locations can be associated with one or more of those attributes.

Example attributes can include one or more names (e.g., a username, a location name, a system name, etc.), one or more identifiers (e.g., a user identifier, a location identifier, a system identifier, a partition identifier, a device identifier, etc.) one or more settings and/or configurations (e.g., the one or more settings can include volume settings such as a maximum volume for the location, an LED status light setting for the locations, hardware/software control configuration such as what buttons/commands should cause what actions, etc.), one or more permissions (e.g., permissions for which users are authorized to access a given location and/or permissions for different types of users), one or more entitlements (e.g., entitlements for the locations, the users and/or devices of the location, such as entitlements to paid features), one or more subscriptions (e.g., subscriptions to a media streaming service provider), one or more points of contact (e.g., admin/support contact person(s)), one or more integrations (e.g., integrations with external services such as a voice assistant service, a social media service, a third party server/application, etc.), one or more preferences (e.g., user preferences in terms of media content, actions to be taken by the playback devices in response to a particular command, playlists, scenes, saved groups, etc.), a physical address, and/or timestamps for relevant events (e.g., when the location was created or updated), among others.

In some instances, a location represents a collection of playback devices that are capable of being grouped to play back media content in synchrony. One or more synchrony groups, or other kinds of groups such as bonded pairs, home theater groups, etc., can exist under a given location. In some instances, when a location is associated with two different partitions of devices in different LANs, those devices can be grouped for example by implementing a group coordinator module with access to both LANs, such as a group coordinator implemented in a cloud server. Example techniques for playback synchronization and/or group coordinator functionalities in the cloud are disclosed in U.S. Pat. Pub. No. 2021/0329330, filed Apr. 16, 2021, entitled “Techniques for Clock Rate Synchronization” and U.S. Pat. Pub. No. 2022/0083310, filed Sep. 10, 2021, entitled “Techniques for Extending the Lifespan of Playback Devices”, both of which are incorporated herein by reference in their entirety.

Diagram 220 illustrates an example of a scenario in which a split of the media playback system 100 has occurred. As explained before in this disclosure, a split can occur when one or more playback devices are connected to a different LAN(s) creating a new partition. In the example of diagram 220, playback device 205 is still in the first partition 215A while playback device 206 is in a second partition 215B. As illustrated in diagram 220, after the split, both partitions 215A and 215B are associated with location 215. As a result, both device 205 and device 206 continue to be part of location 215 despite the partition (e.g., networking) changes.

At this point, the media playback system can be at a state in which the intentionality of the split is unclear. The split could have been caused because playback device 206 was connected to a different LAN. If playback device 206 was moved to a new physical location and/or otherwise intentionally moved to a different LAN to operate in a partition independent of playback device 205, it may be accurate and/or beneficial to associate playback device 206 with a new location. However, if playback device 206 was unintentionally moved to a different LAN, it may be accurate and/or beneficial to forgo, revert or otherwise solve the split.

Because the reason and/or intention for the split may not be clear when the split is detected by the system, in some instances, it may be advantageous to notify the user of the split. The user can then confirm whether the split was intentional or unintentional. The media playback system could wait for a user confirmation of the detected physical/networking split before implementing the split at a system level (e.g., before altering the structure/topology of the system), rather than automatically inferring that the user intended to split the system into two locations.

In instances in which the physical and/or networking split is confirmed as intentional, the media playback system can take action to reflect the split in the media playback system structure/topology (e.g., by associating playback device(s) in the new partition to a different location/location object). This be accomplished, can for example, by reflecting/translating/codifying the split into the computer program code that describes the system's topology (e.g., generating a new location object and/or assigning new attributes such as child nodes and/or partitions and/or devices to the location/location object). Diagram 230 illustrates an example of this scenario, in which a location 235 has been associated with the second partition 215B so that playback device 205 is still associated with location 215 while playback device 206 is now associated with location 235. Location 235 can be assigned by the user (e.g., created/caused to be created by the user and/or selected from a list of available locations) or assigned by the system, as will be described in more detail below.

In the configuration of diagram 230, the media playback system can be said to be fully split. At this point, the physical/networking split (e.g., one or more devices connected to a different LAN) has been implemented in the form of configuration changes to the structure/topology of the system by designating a new location for the new partition. At this point, actions (e.g., a change to an attribute, a command, etc.) related to location 215 will only affect playback device 205 or any collection of devices associated with such location, but not playback device 206. Similarly, actions related to location 235 will only affect playback device 206 or any collection of devices associated with such location, but not playback device 205.

In some instances, devices under a given location can obtain (e.g., access and/or receive) data related to the location (e.g., data related to actions, attributes, commands, settings, etc. for the location). The data can be obtained from a computing system such as a media playback system provider server. The playback devices can periodically update any locally stored data (e.g., state variables) to reflect the location's configuration. Playback devices under a same location could replicate settings such that all devices in such location receive the location's data and can be updated accordingly. In some instances, playback devices can subscribe to a location (e.g., the location they are assigned to) to receive notifications related to the location. The playback devices could also subscribe to a particular device in the system which obtains location data from a source (e.g., the cloud or any other device/location) to obtain notifications from such device.

Referring back to the configuration in diagram 220, in instances in which the split is confirmed as unintentional, the media playback system can forego any action to fully implement the split and/or to reflect the split in the media playback system structure/topology. In some instances, the media playback system can take action to revert the split or to help the user revert the split. The actions can include guiding the user to reconfigure the system to an unsplit configuration, which could imply going back to the configuration shown in diagram 210, merging the two partitions into one and maintaining the association with location 215, etc. The actions can also include deleting/updating any association/mapping created between the playback device 206 and the partition 215B, and/or between the location 215 and the second partition 215B. The actions can also include deleting any instance of partition 215B.

In some instances, the split can be confirmed as intentional, however, the user may wish to maintain the two partitions associated with the same location. An example referenced above would be a “Restaurant” location comprising a “downstairs” and an “upstairs” partition. In FIG. 2, this would imply the system staying in the configuration shown in diagram 220, in which multiple partitions 215A and 215B are associated with a same location 215. The media playback system could also remain in the split configuration illustrated in diagram 220 in instances in which no confirmation regarding the intentionality of the split is received.

In some instances, when the media playback system is in the configuration illustrated in diagram 220, in which multiple partitions 215A and 215B are associated with a same location 215, actions affecting one location (e.g., 215) could affect all the partitions/playback devices associated with such location (e.g., 205 and 206). However, in some instances, the interoperability between devices in different partitions can be limited. For example, depending on the media playback system capabilities and/or network connectivity, playback devices in two different partitions/LANs may not be able to be grouped (e.g., for synchronous playback) even if associated with the same location. Furthermore, in some instances, playback devices in different partitions may not be able to replicate certain settings and/or directly exchange messages and commands. In some instances, playback devices in different partitions/LANs may not be able to perform some of these functions offline (e.g., without an Internet connection or access to a WAN or other network to link the different partitions).

In some instances, in an ideal and/or regular state of operation of the media playback system, locations are to be mapped in a one-to-one correspondence with partitions in a media playback system. For example, each LAN could be mapped to a different location. In those instances, the system state in the configuration of diagram 220 can be said to be a state that requires user resolution (e.g., an unideal state, conflict state or temporary state). In those cases, the user can have the option to either fully split the system to the configuration in diagram 230, or revert the split to the configuration in diagram 210 so that each location only has one partition associated with it.

As illustrated in diagram 230, implementing the split can result in a new node 235 added to the topology representing the new location. As explained before in this disclosure and will be explained below in more detail, this node can be implanted as a data object (location object in this disclosure) with an identifier (location identifier in this disclosure). The location, location object and/or location identifier can be assigned to the playback devices and/or partitions of playback devices or vice-versa, so that the playback devices/partitions are associated with (e.g., mapped to) respective locations.

As also illustrated in diagram 230, detecting the split can result in a new node 215B added to the topology representing the new partition. In some instances, partitions are not necessarily implemented by the system as individual or explicit nodes. Devices could be mapped directly under the location nodes, for example, by associating the location with a list of devices/devices identifiers and some associated network parameters (such as a DHCP server MAC address) that serves to distinguish devices in different partitions/LANs.

Playback devices can be assigned and/or re-assigned to locations or vice-versa. In some instances, playback devices adopt the attributes of the locations they are currently associated with. The attributes can be established at the location level (e.g., stored in association with the location object/location identifier), so that a playback device associated with such location can obtain/access such attributes and be configured to operate as a member of such location. For example, a playback device associated with a location could access a set of attributes (e.g., settings) for the location, such as a given volume, a subscription to a media streaming service, etc. The playback device could adopt the attributes so that the device is able to operate accordingly, for example, to play back music using the media streaming service, at the given volume, etc. Another example would be the ability to turn features on/off for the location. Example features would be broadcasting (such that other devices can broadcast content to the playback devices), explicit content filtering, searching/browsing content, adding media content sources, etc. In some instances, when a feature is enabled/disabled for the location, it can automatically be enabled/disabled for all the devices under such location.

The playback device could access the location attributes from a computing system (e.g., a media playback system server), or from other devices in the location such as other playback devices. In some instances, the playback device could be provided with the attributes when it is associated with the location. For example, a computing system and/or other devices in the location could send the attributes to the playback device when (e.g., upon detecting that) the device has been added to the location, and/or cause the playback device to operate in accordance with such attribute. In some instances, the playback device could request the set of attributes from the computing system and/or other devices in the location when (upon detecting that) the device has been added to the location.

FIG. 2 includes a diagram 240 of a scenario in which, after the implementation of the split described with reference to diagram 230 where location 235 was added, playback device 206 is moved back (e.g., re-assigned) to the location 215. As illustrated, playback device 206 can again be part of partition 215A and/or associated with location 215. At this point, playback device 206 could adopt any attributes of location 215 and therefore be ready to operate in such location. This change in configuration could also cause playback device 206 to be dissociated from any attributes of location 235 and/or the location 235 itself. As explained, a same device can be “moved” between locations (e.g., associated with different locations) and be able to obtain any attributes necessary to operate as a member of the different locations.

In some instances, locations are stable and/or permanent so that, after they are created/added to the topology, they are not removed/deleted and/or do not change unless explicitly confirmed by a user. In this way, after a location is added to the system, it can persist and/or remain unchanged. For instance, locations can exist independent of any network parameter, and/or persist in the system in the presence of networking changes until the changes are resolved/confirmed. Diagram 240 illustrates an example in which location 235 exists in the topology even if there are no playback devices associated with it. Therefore, any attributes of location 235 can remain associated with such location so that if, at any time, any playback device is associated with such location, it can adopt the location attributes and operate accordingly. For example, in a scenario in which playback device 206 is again assigned to location 235, playback device 206 could be dissociated from the attributes of location 215 and adopt the attributes of location 235 so that it is ready to operate in such location.

In some instances, locations can be deleted by the system, even without any user input. For example, a period of time can be defined so that, when a location is empty and/or inactive (e.g., has no devices associated with it, has not been used, etc.) for the period of time, it can be proactively deleted. This period of time can be defined by the users (e.g., system's administrator). The ability to delete empty or inactive locations can be optional to users so that it can be turned on/off at user's convenience. Users could also be notified that a location has been detected as empty and/or inactive. At this time, users could have the option to delete/configure the location, and/or be notified that the location will be deleted unless the user explicitly confirms otherwise, etc.

As illustrated in the example of diagram 240, the partition node 215B no longer exist when there are no playback devices associated with it. In some instances, the partitions can be virtual, semi-persistent and/or non-stable nodes in the topology that are conditioned on whether there are playback devices actively connected to such partition (e.g., playback devices turned on, with cloud connection, etc.). In some instances, the partitions are established based on the network to which the devices are connected so that if there are no devices connected to the network the partition may no longer exist. Therefore, in some instances, it would be beneficial to use the locations to establish more permanent attributes for the playback devices so that those attributes can persist and can be replicated to any partition under the location. For example, an integration with a third-party service (e.g., a voice assistant service) established for partition 215B could be lost in the scenario of diagram 240 if the third-party service was configured to target the partition 215B (e.g., with a partition identifier), which no longer exists. However, if the integration is established for the location 235 (e.g., using a location identifier), it can persist and be used any time due to the permanency and stability of the locations in the topology. In this way, changes such as migration from one router/LAN to another can occur without disrupting the overall behavior of the system by making sure such migrations do not cause non targetable splits/partitions in the systems as they continue to exist under a more stable/permanent node (i.e., the locations). Integrations, commands, configurations, etc. associated with the location/location identifier can continue to work in these scenarios.

An example of the benefits of having a location domain which is stable and permanent can comprise a scenario in which the user moves playback devices between different settings (e.g., different places). For example, a user can have a “vacation home” location for their vacation home with certain attributes (e.g., a media streaming service subscription, equalization settings, alarms, etc.). The user can bring some of their playback devices to the vacation home, assign them to the “vacation home” location, and have them ready to use in accordance with such attributes. The user could then return home and take the playback devices with them. At home, the user could assign the playback devices to their usual “home” location and have them ready to use in accordance with any attributes established for such location. Next summer, when the user returns to the vacation home, the user could bring the same and/or other playback devices and assign them to the “vacation home” location, and such playback devices will be ready to operate in accordance with any attributes established for such location (for example automatically determining user preferences for the given location, media content that the user has listened to in the given location, system configurations such as pre-established groups of devices, volume/equalizations settings, subscriptions associated to the given location, etc.).

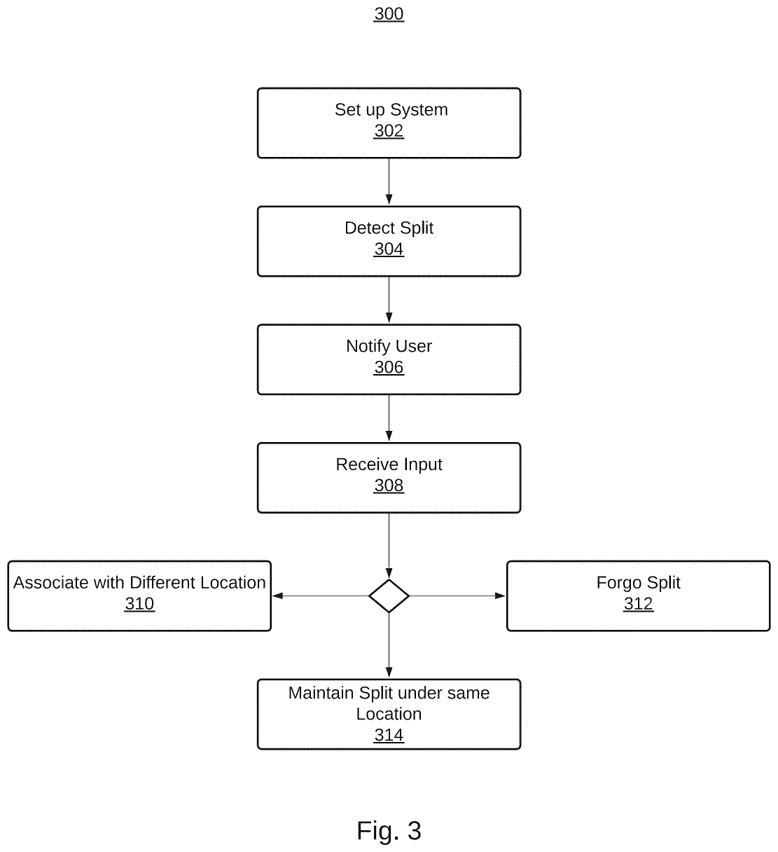

FIG. 3 includes a flowchart 300 for example methods that can be performed by a media playback system, in accordance with embodiments described herein. The methods can be performed by any device (or combination of devices) in the media playback system or associated with the media playback system, such as any of the playback devices, control devices and/or computing devices described with reference to FIGS. 1A-1H. Example implementation of the different blocks of method 300 will be described in the following sections of this disclosure.

Method 300 includes a block 302 of setting up a media playback system. By performing this block, the media playback system can be associated with a user and/or user account and with at least one location, such as in the configuration described with reference to diagram 210 in FIG. 2. This block can include storing an association between the media playback system (or any devices/partitions in the media playback system) with a location identifier and/or a user identifier. Method 300 includes a block 304 of detecting a split of the media playback system. After block 304, the media playback system can be in a configuration where playback devices in two or more partitions of the media playback system can be associated with the same location as they were before the split, such as the configuration described with reference to diagram 220 in FIG. 2.

Method 300 includes a block 306 of notifying the user about the split. As explained before, notifying the user can be advantageous in that, in some instances, the split may have been caused inadvertently. Method 300 includes a block 308 of receiving an input. The input can be to confirm the intentionality of the split and/or to make adjustment to the media playback system configuration. Block 308 can be optional since the system may not receive any input related to the split. Based on the input, the media playback system can execute one of blocks 310, 312 or 314.

The input can be a confirmation that the split was intentional, in which case block 310 of associating the new partition with a different location can be performed. After performing this block the media playback system can be in a configuration where each partition of the media playback system is associated with an individual location, such as the configuration described with reference to diagram 230 in FIG. 2.

The input can be a confirmation that the split was unintentional, in which case block 312 of forgoing (e.g., not implementing and/or reverting) the split can be performed. By executing this block, the media playback system can be back in a configuration where the partitions of the media playback system are merged into a single partition and associated with the same location, such as the configuration described with reference to diagram 210 in FIG. 2.

The input can be a confirmation that the split was intentional but indicate that the user wishes to maintain the different partitions, in which case block 314 of implementing/maintaining the split under the same location can be performed. At block 314, the media playback system can be in a configuration where the different partitions of the media playback system are associated with the same location, such as the configuration described with reference to diagram 220 in FIG. 2. In some instances, if no input is received, the system can proceed to conduct block 314 of implementing/maintaining the split under the same location. In some instances, if no input is received, the system can conduct any of blocks 310, 312, or 314. The determination of which block to conduct if no input is received can be made based on any additional information such as default settings/configurations, preference information accessible to the system (e.g., what the user would prefer to do in cases like this), contextual information (e.g., GPS data, time zone information, etc.) that may help infer whether a new location should be created or not, etc.

### a. Setting Up System

The setup process in block 302 of flowchart 300 can include any steps for configuring the media playback system for operation, such as registering the system with the media playback system provider, creating an account, associating such account with the devices in the system, etc. Example setup and registration procedures are disclosed in U.S. Pub. No. US 2022/0104015, filed Sep. 24, 2021, entitled “Intelligent Setup for Playback Devices”, U.S. Pat. No. 10,303,422, filed Jan. 5, 2016, entitled “Multiple-Device Setup”, and U.S. Pat. No. 8,326,951, filed Jun. 6, 2005, entitled “Establishing a secure wireless network with minimum human intervention”, all of which are incorporated herein by reference in their entirety. With reference back to the example of FIG. 2, after setup the media playback system can be associated with the user 201, for example, by being registered with user 201's account.

In some instances, as part of the setup process, the devices in the system can be provisioned with one or more parameters. Some of those parameters can be parameters (e.g., identifiers) that serve to identify and/or provide an address for the system and/or devices within the system. For example, the devices can be provisioned with a system identifier that identifies each device as belonging to the same system. As another example, the devices can be provisioned with a subsystem identifier that identifies the partition to which the devices are connected. Example techniques for provisioning devices of a media playback system are disclosed in U.S. Pat. No. 8,326,951, filed Jun. 6, 2005, entitled “Establishing a secure wireless network with minimum human intervention” and U.S. Pat. No. 10,602,286, filed Jun. 25, 2018, entitled “controlling multi-site media playback systems”, both of which are incorporated herein by reference in their entirety.

In some instances, the setup process includes generating and storing location information (e.g., a location, location identifier and/or any related mapping or association) for the media playback system. Locations can be created at any time at the user and/or system discretion. In some instances, the user can create locations via a controller application installed in a user device such as a user's phone or desktop, via a web interface, or via any other interface that allows the user to interact with the media playback system provider or other computing system that enables generation of locations.

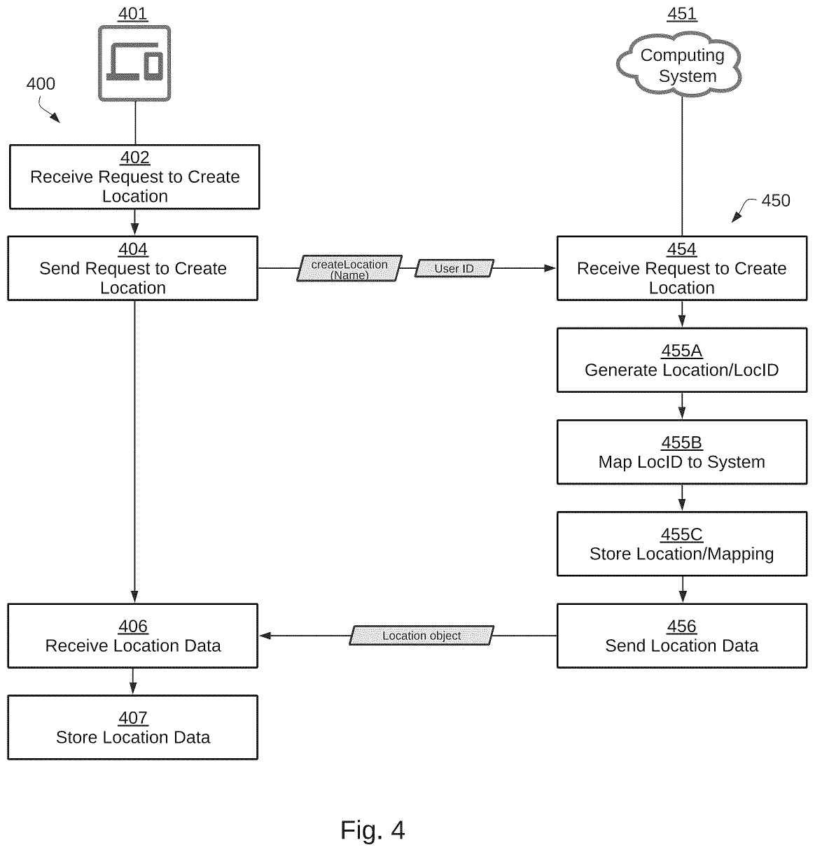

FIG. 4 includes flowcharts for a set of example methods for creating a location, in accordance with embodiments described herein. In some instances, method 400, to the left, can be performed by any device of the media playback system, such as a control device 401 (e.g., via a control application or a web controller). The control device 401 can be the same or similar to the control device(s) 130 described with reference to FIGS. 1A-1H. In some instances, method 450, to the right, can be performed by a computing system 451 of one or more computing devices. The computing system can comprise any combination of local computing devices and/or remote computing devices such as cloud servers (e.g., a server of the media playback system provider). The computing device(s) can comprise the same or similar to the computing devices 106 described with reference to FIGS. 1A-1H. In some instances, the computing system 451 includes the control device 401 so that any of the blocks in method 450 can be performed by the control device 401.

Method 400 comprises a block 402 of receiving a request to create a location. The request can be received in the form of a user input via a user interface of the media playback system. For example, the request can be received via a user interface of the control device (e.g., a graphical interface in a display of the control device). The user interface could provide an option that allows a user to create locations. For example, the control device could display a selectable option in the graphical interface that, when selected, causes the control device to conduct the method 400. The request in block 402 can be received via other means such as via any user interface of the media playback system including hardware controls in the playback devices, voice user interfaces, etc.

In some instances, the user can be required to register with a user account and/or user identifier so that the user has the option to create locations for their system. This registration can be part of the setup process described above, for example, when the user is setting up a playback device in the media playback system. This registration can be done independent of the setup process. For example, the user could simply log into their account with the media playback system provider (e.g., through the control application, control device, a web portal, etc.) and be able to create locations for their account/system.

Method 400 includes a block 404 of sending a request to computing system 451 to create the location. This step can be performed in response to the request received in block 402. In some instances, the control device 401 can generate the location on its own, and block 404 could be omitted or skipped. Block 404 can include sending one or more messages to the computing system 451. The one or more messages can include the request to create the location and other data. In some instances, the one or more messages include data related to the location to be created, such as a location name given by the user. In some instances, the one or more messages include data related to the account and/or user with which the location should be associated, such as a user identifier, a token, etc. In some instances, the one or more messages include data identifying the network from which the request has been sent, such as DHCP server information, server MAC address information, or other network parameter or network derived parameter. In some instances, the one or more messages include data identifying the media payback system, such as a system identifier, a subsystem identifier, etc. In some instances, the one or more messages include data identifying the device from which the request has been sent, such as a device identifier (e.g., a device MAC address, any identifier intrinsic to the device such as an identifier assigned by a device manufacturer, a system—(e.g., cloud, device etc.) generated ID, a device name, etc.). In some instances, the device identifier can be any identifier assigned to the device by the media playback system. In some instances, the device identifier can be derived from any other identifier associated with the device. For example, the device identifier can be derived from the device's MAC address by appending some additional information (e.g., as a suffix, prefix, by hashing it, etc.).

In the example illustrated in FIG. 4, the one or more messages include a user ID, a location name, and a command “CreateLocation(Name)” to create the location with the respective location name. These example messages are for explicative purposes only. For example, a name for the location can be optional and/or replaced/supplemented with any other attribute. The location name may have been provided by the user as part of the input received in step 402. In some instances, the command can be an API call for an API configured to create the location. Block 454 includes the computing system 451 receiving the request to create the location, which can include receiving the one or more messages sent by the control device 401 in block 404.

After receiving the request, the computing system 451 can generate the location and/or respective location identifier for the location as indicated in block 455A. Generating a location can include generating a data object or data structure (e.g., a cloud object or locally stored data structure) that represents the location. This object or data structure can have various attributes or associated metadata that characterizes the location and/or the collection of playback devices to be associated with such location. Example attributes are given before and elsewhere in this disclosure.

The location/location identifier can be mapped/associated with the media playback system and/or account or vice versa, as indicated by block 455B. In some instances, at least part of this association/mapping can occur as part of the execution of block 455A when the locations are generated. For example, locations could be intrinsically “owned” by the user account that generates them so that when locations are generated in block 455A they can be already/intrinsically associated with such user account. In those instances, block 455B could be omitted and/or entail other associations/mappings such as the association with the media playback system and/or playback devices, or a reassociation with another account (e.g., in case of a transfer of ownership). The mapping or association can comprise a mapping or association between the location/location identifier and any characteristic or parameter of the media playback system. For example, the association can comprise an association between the location/location identifier and the user identifier, a system identifier, a subsystem identifier, a network derived parameter, one or more device identifiers (e.g., for all the playback devices associated with the location), etc. A playback device and/or partition/subsystem of playback devices can be associated with a given location by having a device or partition/subsystem identifier associated with the location. For example, a list of device identifiers can be added to the location object for all devices for which such location has been assigned (and/or all devices assigned to the location). As another example, a list of device identifiers can be mapped to the location/location identifier and such mapping can be stored by the system for reference.

The location and/or any related data (e.g., location object, location identifier, mappings, associations, etc.) can be stored by the computing system, as indicated by block 455C. The computing system can store the mapping/association and use it as a reference to make determinations such as whether a new device should be added to a location, whether there has been a system split, etc., as will be explained in more detail below. The mapping could be updated as new locations are created or as devices are assigned different locations. An instance of at least part of this mapping can exist locally for the media playback system, for example stored by the control device and/or any of the playback devices, so that the media playback system has access to the locations without necessarily requiring communication with the computing system.

Method 450 includes a block 456 of sending location data to the control device. In some instances, the location data can also be sent to one or more playback devices in the media playback system at this or a later time. This block can be performed after the computing system has generated the location/location identifier in block 455A. The location data sent in block 456 can include the location object generated in block 455A or at least part of the metadata/attributes for the object such as the location identifier. The location data sent in block 456 can also or alternatively include at least part of the mapping or association established in block 455B. As mentioned, some or all blocks of method 450 could be performed by the control device 401 (e.g., the control device 401 can generate the location, mapping, etc.) and block 456 could be omitted or skipped.

The control device can receive the location data, as indicated in block 406 and alternatively store such location data, as indicated in block 407. Block 407 can include updating any local records that the control device and/or media playback system can have regarding the locations structure. For example, block 407 can include the control device adding the new location to a list of locations for the media playback system. Method 400 could alternatively include displaying an indication of the newly created location and/or at least part of the location data. For example, the control device could display an indication based on the received location data. In some instances, the computing system 450 can cause the control device to display the indication, for example as part of sending the location data to the control device. The indication can include a notification that a new location has been created and/or that a location has changed. The indication can include any data related to the location such as the location name, the devices that are currently associated with such location (if any), etc. The indication could also include a list of locations for the media playback system.

In some instances, some of the blocks in FIG. 4 can be implemented independent of the hardware (e.g., playback devices) that is going to be used for the media playback system. For example, a user could create a location when at least one device in the media playback system is purchased, and/or when the user signs up for a media playback system account before purchasing or without having received their playback devices. Locations, and their respective location identifiers, can be tied to a user and/or user identifier so that it can be possible to create a location/location identifier based on the user/user identifier before users have any playback devices in hand. This could enable configuration of some aspects of the system beforehand in that users can establish certain attributes (e.g., add music services, set preferences, settings and permissions, etc.) prior to receiving their playback devices. When a playback device is received, the device can be assigned to the previously created location, and the payback device can be ready to operate in such location accordingly by obtaining the location configurations/attributes.

Locations, such as the locations created/stored in the various blocks of method 400/450, or any other locations created by the system, can be accessed (e.g., viewed, managed, modified, deleted, etc.) at any time. The locations can be accessed via a user interface, such as via the graphical interface of the control device 401, or a user interface of any other device in the media playback system. For example, the user could request location information via voice command received by any playback device the media playback system.

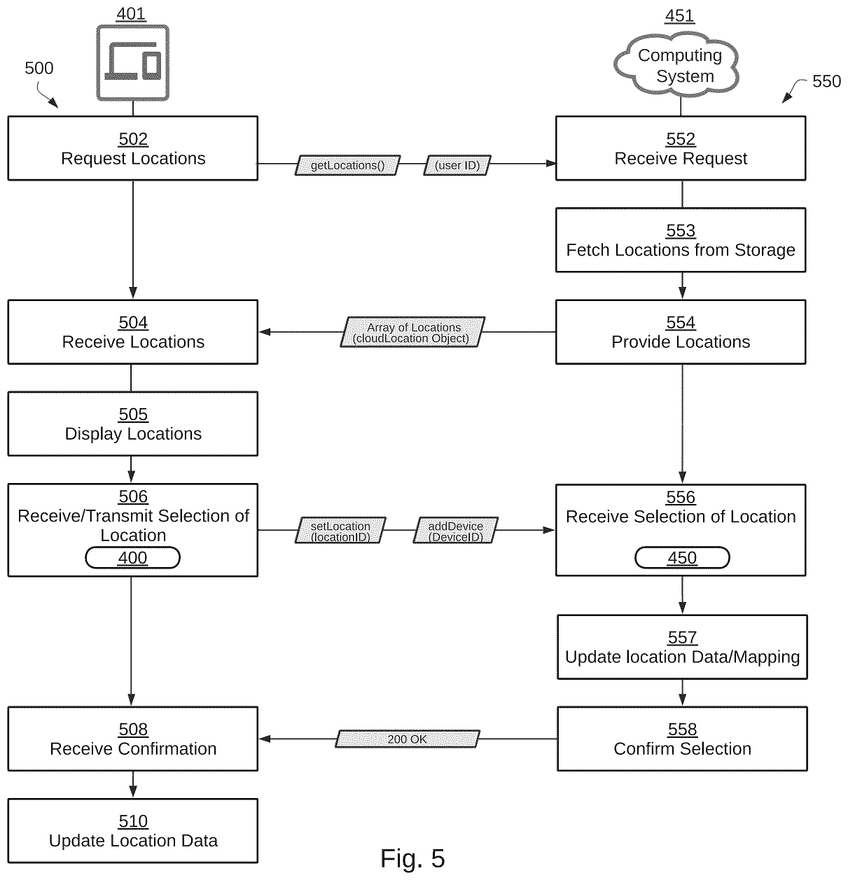

FIG. 5 includes a set of flowcharts for a set of example methods for accessing a location, in accordance with embodiments described herein. As with the example in FIG. 4, in some instances, method 500, to the left, can be performed by a device of the media playback system, such as control device 401. In some instances, method 550, to the right, can be performed by a computing system 451 of one or more computing devices. In some instances, the computing system 451 can include any device of the media playback system, such as the control device 401. In this way, any of the blocks in method 550 can be performed locally by the media playback system, for example in instances in which the locations are stored locally by one or more devices in the system.

Method 500 includes a block 502 of the control device 401 (or any other device in the media playback system) sending a request for location information. Block 502 can be performed in response to an input, such as a user input, requesting the locations. For example, the control device could display a selectable indication that when selected, causes the control device to display all the locations available for the media playback system. The selection could cause the control device to send the request in block 502 to obtain the locations. The request sent in block 502 can include or be sent in addition to one or more messages. The one or more messages can include a command to obtain the locations, such as the getLocations( ) command illustrated in FIG. 5. In some instances, the command comprises an API call for an API that provides the locations.

The one or more messages can include additional data. For example, the one or more messages can include data to identify a user for whom the locations are being requested, such as a user ID, a token, etc. The one or more messages can also or alternatively include data to identify the media playback system for which the locations are being requested, such as a system identifier. The one or more messages can also or alternatively include data to identify the partition of the media playback system for which the locations are being requested, such as a partition identifier. The one or more messages can also or alternatively include data to identify the device(s) in the media playback system for which the locations are being requested, such as a device identifier.

Method 550 includes a block 552 of receiving the request. Block 552 can include receiving the one or messages sent in block 502, including the command and any additional data. The computing system 451 can use the data sent with the request to fetch the locations from the storage. The locations can be any locations stored for example during block 455C of method 450 or any location created by the system. In some instances, the additional data received with the request includes a user identifier. In those instances, the computing system 451 can use the user identifier to fetch the locations belonging to/associated with such user identifier. In some instances, the additional data received with the request includes a system identifier. In those instances, the computing system 451 can use the system identifier to fetch the locations belonging to/associated with such system. In some instances, the additional data received with the request includes a partition identifier. In those instances, the computing system 451 can use the partition identifier to fetch the location associated with such partition. In some instances, the additional data received with the request includes a device identifier. In those instances, the computing system 451 can use the device identifier to fetch the location associated with such device. In some instances, the additional data received with the request may not be used directly by the computing system to fetch the locations from the storage. The computing system may instead use the additional data to obtain other data that can be used to find the location, for example through the mappings created/stored in block 455C of method 450.

In some instances, the request sent/received in blocks 502/552 of methods 500/550 can be a request for a specific location. For example, the additional data sent with the request can include data identifying a particular location, such as a location identifier or location name. In such case, the computing system can use this data to obtain details (e.g., the location object and/or data related to it) for the particular location.

After the computing system 451 has obtained the location(s) and/or locations data, the computing system can provide such data to the media playback system. For example, the computing system can provide such data to the control device, as indicated in block 554. Alternatively or in combination, the computing system can provide such data to other devices in the system such as to any playback device in the system.

The locations data can be sent in one or more messages. In some instances, the locations data can include an array of all the locations identified by the computing system. In some instances, the locations data can include one or more location objects corresponding to the identified locations. In some instances, the locations data can include one or more location names, location identifiers and/or details/metadata for the identified locations.

Any device in the media playback system can receive the location data provided in block 554. For example, the control device can receive the locations data, as indicated in block 504. At this point the devices in the media playback system could optionally store this data and/or update any location data locally stored. The devices could also optionally replicate such data to other devices in the media playback system. The devices could also optionally provide an indication of the location data (e.g., a list of location names) to the user. For example, the control device (or any other device in the media playback system that includes a display) could optionally display the locations in a graphical interface based on the data received from the computing system, as indicated in block 505. Alternatively or in combination, any playback device in the system could provide an audible indication to the user, such as a list of locations/location names.

In some instances, the media playback system can be configured to allow selection of a location, for example to assign such location to the system, a partition of the system, and/or at least one device in the system. The location can be selected, for example, from the locations provided in block 554. Block 506 includes the control device receiving a selection of a location. The location can be selected from the list of locations displayed in block 505. The selection can be received from a user via the graphical interface. For example, the locations displayed in the list of locations could comprise respective selectable indications that, when selected, cause the respective location to be selected. The selection can be received from a user via other means, such as via a voice command. For example, the user could give a voice input comprising the name of the location the user wishes to select. The voice command can be in response to an audible indication received from the system, for example in response to the data received in block 504. The control device and/or any device that receives the selection can transmit an indication of the selection to the computing system, as indicated in block 506.

The indication transmitted in block 506 can include one or more messages. The one or more messages can include data identifying the selected location, such as a location name or location identifier. The one or more messages can include a command to record the selection of the location, such as the setLocation(LocationID) command illustrated in the example of FIG. 5. The command can be an API call for an API that creates the association between the location identifier and any indicated device identifier and/or partition identifier.

In some instances, the selection in block 506 can be made in order to assign such location to a device (for example a device being set up or otherwise being assigned a location). The device can be any device in the media playback system such as the control device or any of the playback devices. The one or more messages can include one or more device identifiers identifying the devices that should be associated with the selected location. The one or more messages can include a command to associate the location with the device, such as the addDevice(deviceID) command illustrated in the example of FIG. 5. The command can be an API call for an IPI that adds/associates a device to a location.

In some instances, block 506 can include receiving a selection for a location which is not among the locations provided in block 554. For example, the graphical interface could include a selectable indication to create a new location. Selecting such option could cause the system to perform certain blocks of the methods described with reference to FIG. 4 to create a new location. The newly created location can then be added to the list or otherwise displayed for selection. In some instances, when a new location is created during the process of selecting a location for a given device, the action of selecting the option of creating the new location can intrinsically involve the selection of the newly created location in block 506.

The computing system can receive the selection in block 556 and, based on the selection and/or the data/commands received, update the location data such as the location object, the mapping and/or associations for the selected location, as indicated in block 557. Updating the location data can include associating devices to the location. For example, a location object can be updated to include data identifying the devices that are associated with such location. Similarly, the mapping can be updated to reflect the selection and any resulting assignment of locations. The computing system could optionally confirm the selection, as indicated in block 558. The computing system could also optionally transmit the updated location data to the media playback system.

The media playback system (e.g., the control device 401) can receive the confirmation, as indicated in block 508, and/or any updated location data. The media playback system can optionally update the location data stored locally, if any, based on the selection in block 506 and/or any data received from the computing system. At this point, the location data can be passed on to other devices, for example the control device could replicate this information to playback devices in the same LAN/partition as the control device. In some instances, the other devices obtain the location information directly from the computing system or other devices in the LAN, as will be described in more detail below.

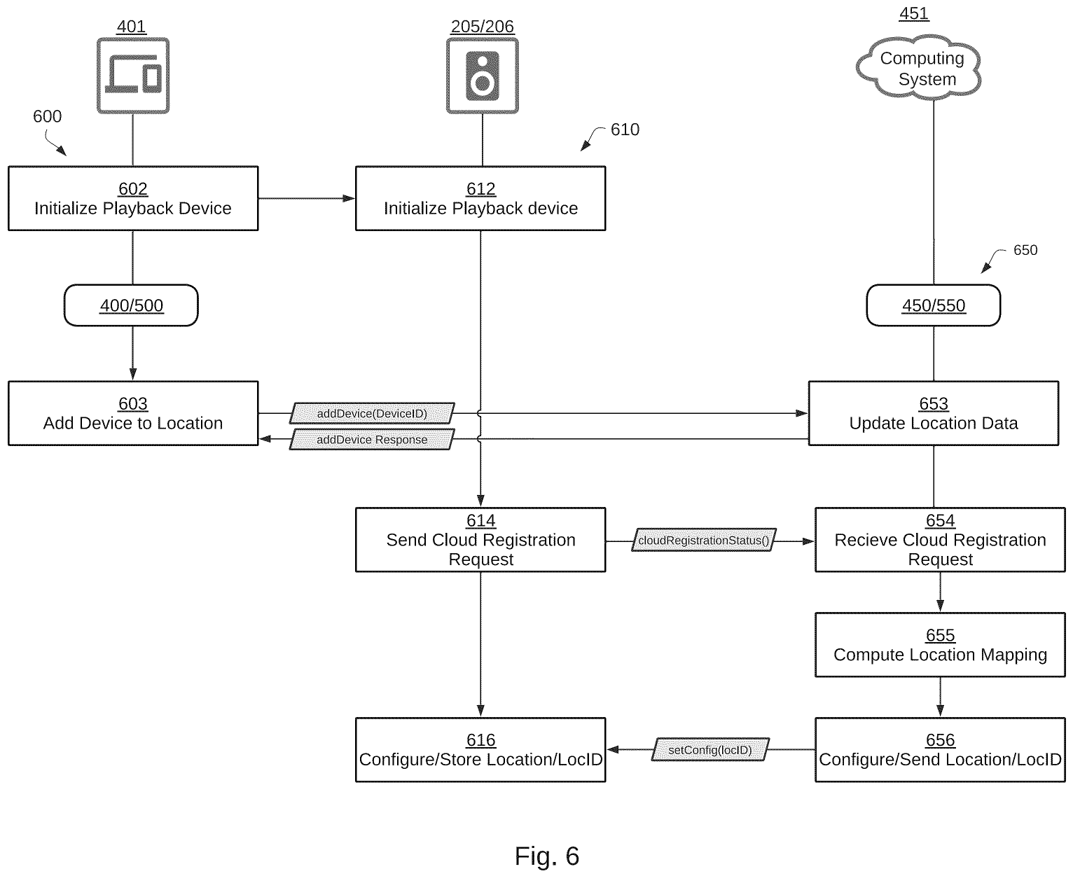

FIG. 6 includes flowcharts for a set of example methods for setting up playback devices of a media playback system with a location, in accordance with embodiments described herein. In the example of FIG. 6, the control device 401 may or may not have performed any of the methods described with reference to FIGS. 4 and 5, which means that the control device 401 and/or the computing system 451 may or may not be aware of any location information for the media playback system. As with the previous examples, blocks in method 600 to the left can be performed by the control device and blocks in method 650 to the right can be performed by the computing system/device. FIG. 6 includes a method 610 which can be performed by a playback device of the media playback system such as playback devices 205/206 introduced with reference to FIG. 2 or any of the playback devices described with reference to media playback system 100. FIG. 6 illustrates just an example implementation and any of the blocks in the example of FIG. 6 can be performed by other devices in the system. For example, the computing system can perform blocks of method 600 and vice-versa.

Methods 600 and 610 include respective blocks 602 and 612 of initializing a playback device in the media playback system. This block can include any steps for setting up a playback device in the media playback system, such as the process described in U.S. Pub. No. US 2022/0104015, filed Sep. 24, 2021, entitled “Intelligent Setup for Playback Devices”, which was incorporated by reference above. Block 602 can include the control device detecting that there is a playback device available for configuration. In response to such detection, the control device can conduct the setup process. Block 612 can include the playback device advertising that it is available for configuration, and/or sending one or more messages to the control device requesting information for the configuration. In some instances, block 602 could be performed at least in part by the computing system 451. For example, the computing system could perform some of the blocks to set up the playback device and/or provide the playback device with some of the configuration data.

As part of the setup process, the control device can pass, in one or more messages, certain parameters and/or configuration data to the playback device. The control device can send data such as data to register the playback device with the user and/or user account for the media playback system. This data can include a user identifier. The control device can also or alternatively send data identifying the media playback system such as a system identifier. The control device can also or alternatively send data identifying a partition of the media playback system such as a partition and/or network identifier. In some instances, at least part of the parameters and/or configuration data can be generated/provisioned by the controller (e.g., the system identifier, the subsystem identifier, etc.). In some instances, at least part of the parameters and/or configuration data can be obtained from the computing system, for example as part of a registration process.

In some instances, blocks 602/612 can include sending/receiving, as part of the one or more messages in the configuration process, location information from the control device to the playback device. For example, the control device can have location information stored (e.g., from conducting any of the methods in FIGS. 4 and 5). This location information (e.g., a location identifier) can be sent to the playback device as part of block 602. In some instances, the location information is passed to the device so that such location is assigned to the playback device (i.e., to associate the payback device with such location). For example, the control device may send location information stored locally to any device of the media playback system detected in the same LAN.

In some instances and as illustrated in the example of FIG. 6, any of the blocks of the methods 400/450 and 500/550 of FIGS. 4 and 5 could be performed when or after the playback device is initialized. For example, as part of or after the setup process, an existing location can be selected and/or a new one can be created for the playback device being initialized/set up.

In cases in which the control device transmits the location information to the playback device, the control device could update the location information to reflect the association of the playback device with the location and/or cause the computing system to update such information. For example, the control device could add, and/or cause the computing system to add the playback device 205/206 to the location (for example by updating a mapping between the location and devices associated with such location), as indicated in blocks 603 and 653 of methods 600 and 650. At this point, the control device could send one or more messages to the computing system with for example an instruction or command (e.g., “addDevice(DeviceID)”) to add the device to the location. As illustrated, a response can be received in the form of one or more messages indicating the status of the request (e.g., whether the operation succeeded or not).

In some instances, the playback device being configured has access to and/or communication with the computing system and can conduct at least part of the actions in block 603. For example, the playback device can be able to instruct the computing system to add the device to the location. In some other instances, the playback device can communicate with the control device over a LAN for the setup process but does not have access to and/or communication with the computing system yet. In this case, any communication with the computing system during the setup process can occur through the control device.

As illustrated in block 653 of method 650, the computing device could update the location information (e.g., location object and/or any mappings) whenever it receives information and/or commands to do so. For example, the control device and/or playback device could send an instruction to add the device to the location, as explained with reference to block 603, which could cause the computing system to update the location data accordingly, for example by adding the device to the location object or otherwise associating the device identifier with the location/location identifier.

In some instances, the playback device can be able to communicate with the computing system during or after setup. The playback device can communicate with the computing system to register with the computing system. In some instances, the playback device can be initialized by the control device, and proceed to register with the computing system using any parameters provided by the control device. The playback device can register with the computing system so that the computing system knows that the playback device is active and create the necessary associations, for example to the media playback system in which the device has been activated. Example registration procedures are provided in U.S. Pat. No. 10,602,286, filed Jun. 25, 2018, entitled “controlling multi-site media playback systems”, which was incorporated by reference above.

Method 610 includes a block 614 of transmitting, in one or more messages, a registration request to the computing system. The registration request can be sent at any point in time and independent from execution of block 612. For example, the registration request can be sent after the playback device has been initialized by the controller, once the playback device has access to a network that allows communication with the computing system such as the Internet.

The registration request can include a status message, such as the cloudRegistrationStatus( ) message illustrated in the example of FIG. 6, indicating that the playback device is active and/or comprising any data indicative of the status of the device. The registration request can also include any data identifying the device, such as a device identifier. The registration request can also include any data acquired during the setup process, such as data identifying the media playback system (e.g., a system identifier), data identifying a partition of the media playback system (e.g., a partition identifier), etc. The registration request can also include any data identifying a network, such as a LAN, to which the playback device is connected. In some instances, the data identifying the network can be a parameter of the network such as a DHCP server MAC address or any parameter derived from network information, such as a hash of any parameter in the LAN. In some instances, this parameter can be the partition identifier.

In some instances, the registration request can include location data, such as a location identifier. The location data could have been passed by the control device during the setup process and/or obtained by the playback device from other devices in the media playback system, for example from other playback devices in the LAN. In other instances, the registration request could not include any location data. For example, the playback device may not have been setup with any location data during the setup process. In other instances, even if the playback device is in possession of any location data (e.g., from the setup process or otherwise), such data may not be included in the registration request.

The computing system can receive the registration request, as indicated in block 654, which can include receiving the one or more messages sent by the playback device in block 614. After receiving the request, the computing system could check and/or store the data received from the playback device. In instances in which the registration request does not include location information, the computing system can determine a location for the device. The computing system can determine such location by, for example, computing one or more mappings and accessing data stored by the computing device, as indicated in block 655. Those mappings/data could have been stored previously, for example as part of the processes described with reference to FIGS. 4 and 5.

In some instances, the computing system could determine the location for the playback device based on data received in the registration request. For example, the registration request could include a device identifier. The device identifier could be used by the computer system to look up data (e.g., by computing stored mappings) and determine what location is associated with the device. An association of the location with the device could have been created, for example, in scenarios in which blocks 603 and 653 were previously executed, where the computing system may have added the device or device identifier to the location or location object at that time.

In some instances, the computing device may not be able to determine the location data. For example, the location data may not exist or the association with the particular playback device may not have been registered by the computing system. In those instances, the computing system can use any other data to determine a location for the playback device. For example, the computing system could use data identifying the partition or LAN in which the playback device is connected to compute a mapping and determine a location associated with such partition and/or LAN.

In some instances, the computing system may be unable to determine a location for the playback device. In those instances, the computing system could return an error message to the playback device and/or control device indicating some configuration issue. In other instances, the user can be notified that a particular device is not/could not be associated with any location yet to allow the user to select/create a location. In other instances, if the location data does not exist for a given device and cannot be determined from the data received in the registration request, the computing system can automatically create a location and associate it with the device. In some instances, the location and/or respective associations can be created by conducting blocks similar to blocks 455A-C described with reference to FIG. 4. An indication can be provided to the user so that the user can name such location or change locations if necessary. For example, in an instance in which the user hasn't created any locations for their system, the system can create (e.g., backfill) locations based on network data (e.g., DHCP server MAC address). The user can then be able to name those locations and assign them to devices as desired.

Method 650 includes a block 656 of configuring and/or sending location data (e.g., the determined location, location identifier, location object and/or other configuration data) to the playback device. The data can be sent as part of one or more configuration messages sent to the playback device in response to the registration request. The one or more messages can include commands such as the “setConfig(locID)” command in the example of FIG. 6. The command could cause the playback device to take an action, such as registering an associated location based on the received data and/or storing the received data, as indicated in block 616 of method 610. At this point, the playback device could also adopt (e.g., obtain from the computing system or other devices in the same location) any attributes of the assigned location so that it is ready to operate accordingly.

In some instances, the registration request sent in block 614 does include location data. For example, the registration request can include a location identifier passed by the control device to the playback device or otherwise obtained by the playback device. In those instances, block 655 could include the computing system computing the mapping and checking if the data exists in the computing system records and/or if it matches the computing system records. If the data does not exist, the computing system could store it and create/update any association between the device and the location. If the data exists but does not match the computing system record, this may be an indication of an issue, such as that one of the computing systems and/or playback device has the incorrect data, that the playback device changed networks, that there is a networking issue, etc. In some instances, at this point, the user could be prompted for resolution. In other instances, the computing system could automatically correct/re-a-assign a location to the device (e.g., via a setConfig command as explained before).

The process described with reference to FIG. 6 can be performed for/by any number of playback devices in the media playback system. Playback devices subsequently added and/or to be configured at a later time could obtain data from playback devices already configured. For example, playback devices to be configured at a later time could obtain data from playback devices in the same LAN. In some instances, subsequent devices for which the user, system, partition and/or network data (e.g., LAN data) match can be assigned the same location by the computing system.

A situation may arise in which different playback devices belonging to the same system/user send registration requests from different LANs. For example, two or more requests may include common data such as a user ID and/or a system ID indicating that the devices belong to the same system/user, but each request can include and/or be associated with different DHCP server MAC addresses or partition identifiers. In some instances, this could be an indication of a split in the media playback system.

### b. Detect Split

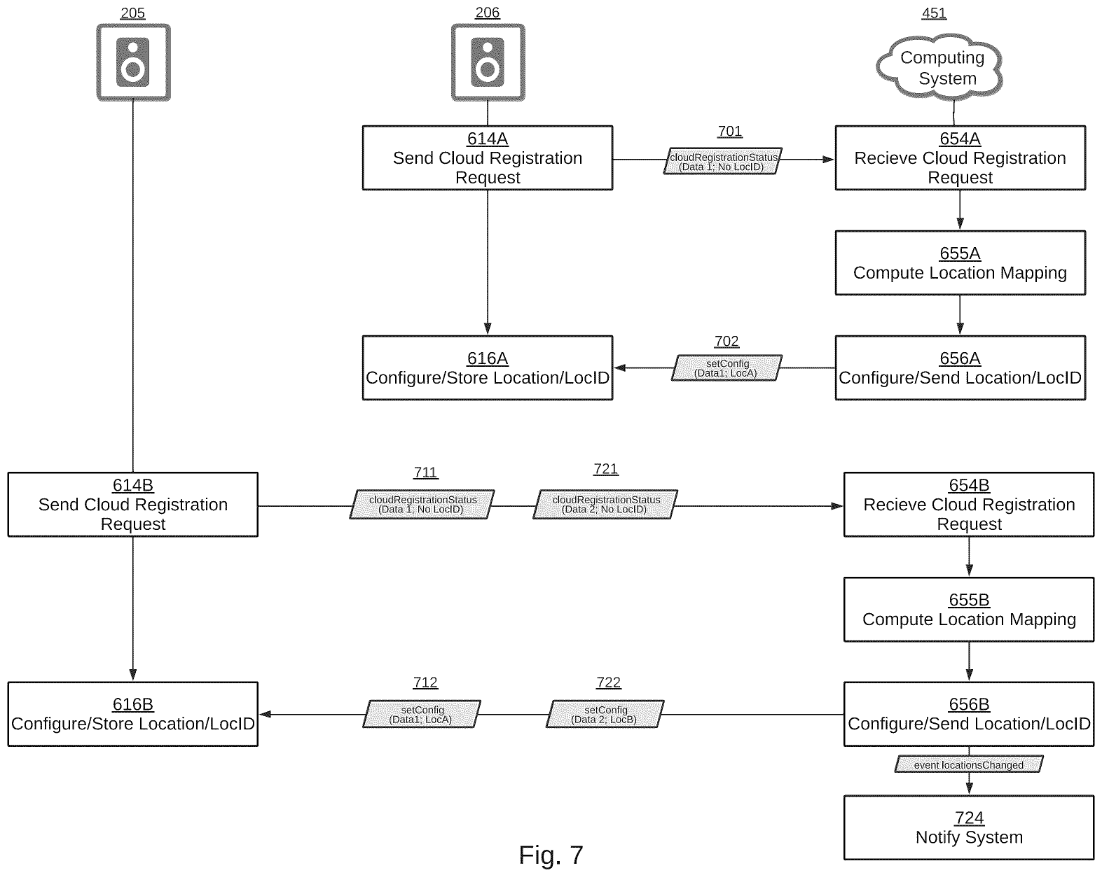

FIG. 7 illustrates an example scenario in which two playback devices, such as playback device 205 and 206, register with the computing system, in accordance with some of the blocks of the methods described with reference to FIG. 6. Blocks 614A/614B, 616A/616B, 654A/654B, 655A/655B and 656A/656B can be instances of blocks 614, 616, 654, 655, 656 described with reference to FIG. 6, respectively. The example in FIG. 7 illustrates a scenario in which the playback devices obtain the location data upon registration with the computing system. Before that, the playback devices may not have any location data associated with them (i.e., the system may not have conducted the methods in FIGS. 3 and 4). Alternatively, the playback devices may have location data obtained from other devices in the LAN, but may still not provide such data to the computing system as part of the registration process in order to obtain updated data from the computing system.

As illustrated in a first example registration request 701, playback device 206 can send, in one or more messages, first data (Data1) to the computing device, and no location data. The first data (Data1) can include data identifying the system and/or the user. The first data (Data1) can also include data identifying a partition and/or network to which the device is connected, such as a partition identifier or a network identifier such as DHCP server data. Other data can be sent as part of or in addition to the first data (Data1), such as data specific to the device (e.g., a device identifier).

Executing block 655A can include computing a mapping for the received data, such as a mapping for any received user identifier and/or network data. Block 655A can include updating and/or generating any mapping to reflect location information. For example, this block can include generating a location/location identifier to be associated with at least part of the received first data (Data1) and/or creating/updating a mapping between any of the parameters included in the first data (e.g., network data) and the newly created location. The location data can be sent to the playback device 206 in a configuration message 702. As illustrated, a location “LocA” has been created/selected and sent/assigned based on or in association with the first data “Data1” in the example of FIG. 7.

As illustrated in a second example registration request 711, another playback device 205 could also send a registration request to the computing device, with no location data. The registration request can comprise at least part of the first data (Data1) and/or data that corresponds to at least part of the first data (Data1) sent by playback device 206 with registration request 701. Other data (e.g., data different from the data sent by playback device 206 in request 701) can be sent as part of or in addition to any data corresponding to the first data (Data1), such as data specific to the device (e.g., a device identifier). Executing block 655B would include computing a mapping for the received data, such as a mapping for the received user identifier and/or network data.

In this example, location “LocA” has been created in block 655A based on or in association with one or more attributes/parameters included in the first data “Data1” so that a mapping between one or more attributes/parameters in the first data “Data1” and a location (LocA) already exists. The computing device could then return/assign the same location (LocA) to the playback device 205 based on the corresponding first data (Data 1). The location data can be sent to the playback device 205 in a configuration message 712. In this example, it is assumed that, since at least part of the data (Data1) is the same (or at least one or more parameters in Data1 is the same), the devices 205 and 206 are in the same partition/network and therefore can be associated with the same location. For example, if the first data (Data1) includes a partition identifier which is the same in both registration requests 701 and 711, the computing system could infer that the playback devices are in the same location (LocA). As another example, if the first data (Data1) includes a network identifier which is the same in both registration requests 701 and 711, the computing system could infer that the playback devices are in the same location (LocA). Other examples are possible. While aspects of the first data (Data1) can be the same for both registration requests 701 and 711, other data can be sent with each registration request that may not be the same. For example, each device could include a device identifier in the registration request which would be different from other devices. Similarly, each device could include timestamps or other contextual data for when the request was transmitted that may be different for each request. In this way, part of the data sent with the registration requests can be different for each device/request (e.g., a device identifier, timestamps, context, etc.), and part of the data could be the same or correspondent (user ID, system ID, partition ID, network information identifying the network to which the device is connected, etc.) when the devices belong to the same user, system, partition, network, etc., for example.

In some instances, more than one attribute/parameter in the first data (Data 1) can be analyzed/computed to determine whether the playback devices are in the same location. For example, the first data (Data1) could include data identifying a user and/or a system (e.g., a user identifier, a token and/or a system identifier). The computing system could infer that the playback devices are in the same location when a combination of data (e.g., the more than one parameter) matches and/or already exist, for example when their registration requests indicate that they are associated with (e.g., belong to) the same user/system and are also in the same network and/or partition. In this way, playback devices belonging to different users and/or systems can be differentiated even if they are in the same LAN (e.g., for roommates each having their own media playback system). Similarly, two playback devices belonging to the same user/system but not in the same network/partition may be associated with different locations but under the same user/system in the topology based on this data.

In some instances, inferring that the playback devices are in the same location from the received data (as in the example described with reference to configuration messages 702 and 712) may not be appropriate for situations in which the user wishes to create/assign different locations to devices in the same LAN. Those scenarios can be addressed by manually creating and assigning locations, for example by performing any of the methods described with reference to FIGS. 4 and 5. The examples described in FIG. 7 refer to specific situations in which the computing system can “backfill” the location information when not available and/or when none is present, but the user could update and/or customize this information as needed.

In some instances, only a portion of the data received with the registration requests is considered in the determination of whether the devices should be assigned the same location. For example, the computing system could determine that the user identifier and the network identifier are the same in requests 701 and 711 and therefore assign the same location to the devices in the responses 702 and 712. However, as previously mentioned, the registration request can include other data in addition to any corresponding “Data 1”, such as a device identifier, which would not be the same for both requests since the requests are being sent from different devices.

A related but different example is illustrated with a third registration request 721. Registration request 721 could be sent instead of registration request 711. In this case, the registration message includes second data “Data 2”, and no location data. The second data “Data 2” can be different from the first data “Data 1” in at least one attribute, aspect or parameter. For example, the second data (Data2) can include a different partition identifier and/or network identifier. In this case, computing the mapping in block 655B may result in no location associated with that combination of data. Therefore, block 655B can include generating/selecting a new location/location identifier and/or any respective mapping. A configuration message 722 can then be sent to the playback devices comprising the new location data, in response to the registration request 721. As illustrated, a different location “LocB” has been created/assigned based on or in association with the second data “Data2”. At this point (or at any point where there is a change in location data such as when a new location is created or a location is updated), the media playback system could be notified of the change in location data. For example, the control device could be notified with a locationChanged event, as illustrated in block 724 FIG. 7. The media playback system (e.g., the control device) could in turn notify the user of the change in locations (e.g., via any user interface of the media playback system, or via any other means such as via email or text message using contact information associated with the user account).

In some instances, the playback device 205 could send additional data in addition to the second data (Data 2) as part of or in addition to registration request 721. The additional data can have at least one attribute, aspect or parameter in common with the first data (Data 1) sent by playback device 206 with registration request 701. For example, the common data can include the same user identifier or system identifier, or some data indicating that both playback devices belong to the same system/user. As explained before, this data can be used to determine that the playback devices are in a same system and therefore create/update the locations under such user/system.

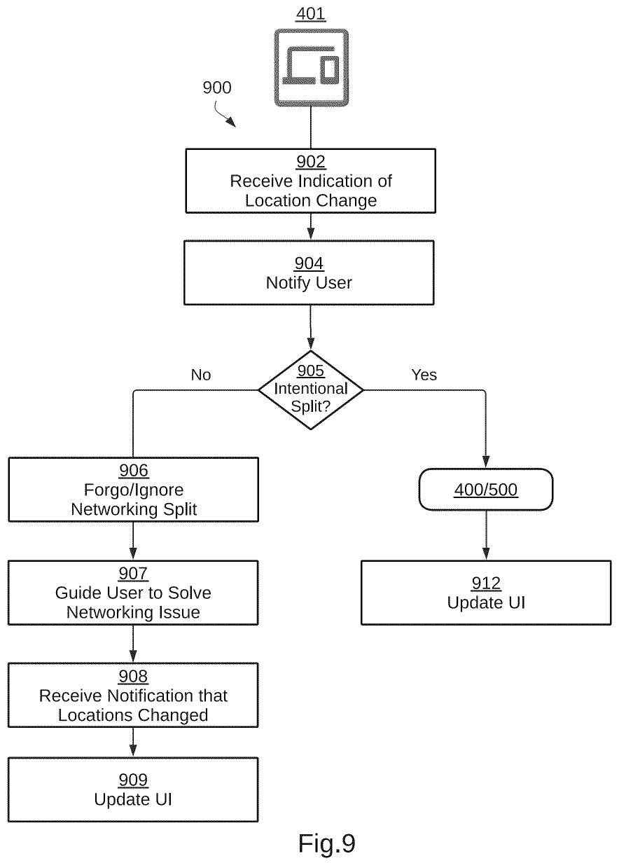

In some instances, before associating the playback device 205 with a new location (LocB), the user could be notified and given the option to create a new location or re-arrange the system so that playback device 205 is in the desired network, as will be explained with reference to FIG. 9. In this way, in some instances, locations can both be caused to be created by the user and/or automatically created by the computing system. In some instances, the computing system can create locations to backfill any data not provided by the user, such as in the examples of FIG. 7 where the location data was not provided by the playback devices.

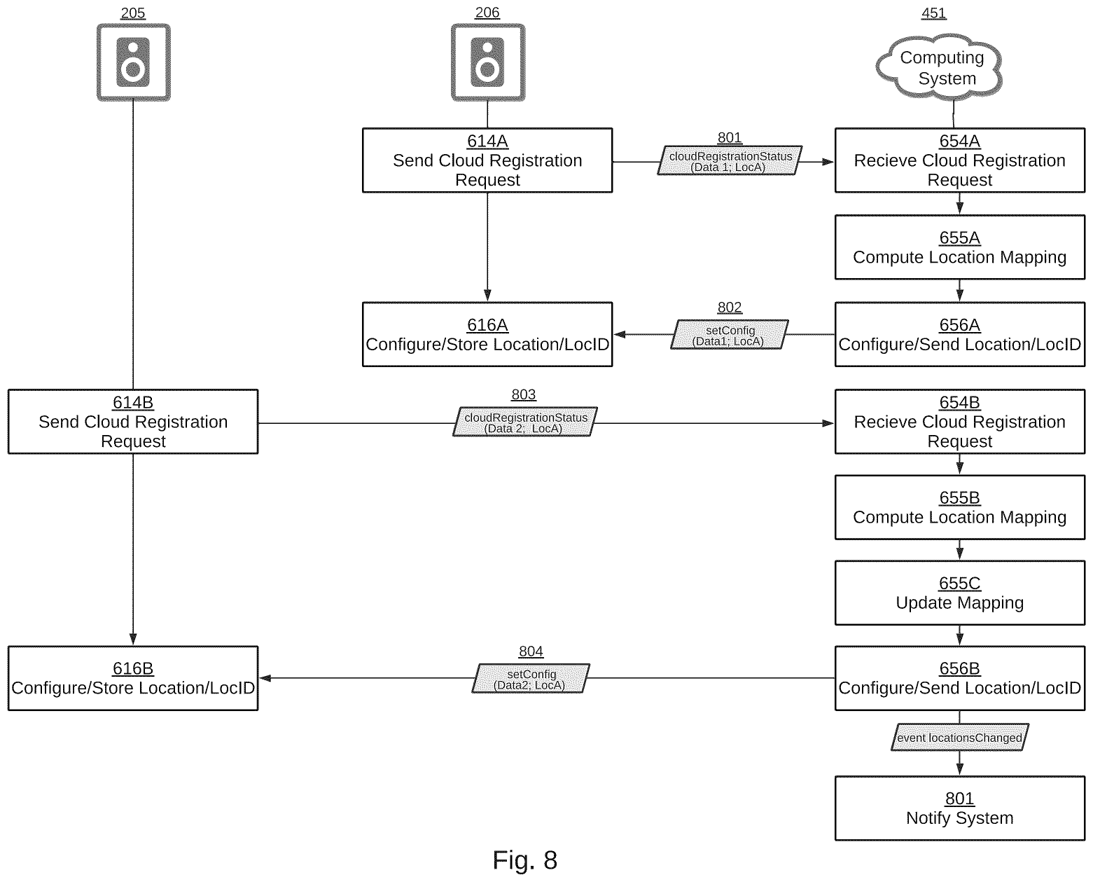

In some instances, registration request 721 could be sent after the processing of a previous registration requests such as registration request 711 (e.g., when the playback device is in a different state, has been connected to a different network, etc.). In this case, the registration request could include the second data “Data 2” and any location data previously assigned (e.g., LocA sent with message 712). The computing system can then take action (e.g., update the mapping, update the location information, notify the user, etc.) accordingly. This scenario will be described in more detail with reference to the example in FIG. 8.

FIG. 8 illustrates a different example scenario in which two playback devices, such as playback device 205 and 206, register with the computing system 451, in accordance with some of the blocks of the methods described with reference to FIG. 6. Blocks 614A/614B, 616A/616B, 654A/654B, 655A/655B and 656A/656B can be instances of blocks 614, 616, 654, 655, 656 of FIG. 6, respectively. Unlike the example in FIG. 7, the example in FIG. 8 illustrates a scenario in which the playback devices provide location data upon registration with the computing system. In some instances, registration messages are not exclusive to the setup process and can in fact be sent at any time (e.g., as part of a status report). The example scenario illustrated in FIG. 8, for example, can happen at any time after the devices are configured and being used in the system. For example, the example scenario illustrated in FIG. 8 can happen when the devices are registering with the computing system and/or at any time after the devices have registered with the computing system (e.g., after performing the methods of FIGS. 6 and/or 7).

In some instances, registration messages can be triggered and/or be sent in response to events, such as when the status of the playback device changes. Example of those events include when the device is turned on, when the device is grouped with another device(s), when the device is connected to a new network, etc. In some instances, registration messages can be sent periodically (e.g., at a given frequency) so that the computing system keeps an accurate/up-to-date image of the playback device status.

The scenario in FIG. 8 illustrates playback device 206 sending a registration message 801 to the computing system including first data “Data1” and first location data “LocA”. The computing system can compute the mapping for LocA and determine that the data received in the first data (Data 1) matches the existing mapping. The computing system can then send configuration message 802 confirming the data and/or mapping.

FIG. 8 also illustrates playback device 205 sending a registration message 803 to the computing system including second data “Data 2” and the same first location data “LocA”. The first data (Data 1) and the second data (Data 2) can have at least one aspect or attribute which is different, such as data identifying the partition and or network to which the devices are connected. The second data (Data 2) (or any additional data sent as part of the execution of block 614B) can have at least one attribute in common with the first data (Data 1) (or any additional data sent as part of the execution of block 614A), such as a user identifier and/or a system identifier.

When the computing system computes the mapping in block 655B, it can determine that at least one parameter in the second data (Data 2) is not mapped to the first location LocA. For example, the computing system may determine that the data identifying the network to which the device is connected may be different than a network to which other devices (e.g., playback device 206) in location LocA are connected. In this case, block 655B can include updating the mapping (block 655C), to include the association of device 205 and/or any data in the second data (Data 2) with locA. For example, the computing system can map any new network information or partition information indicated in the second data (Data 2) to the location (LocA) so that the location is now associated with the new network or partition. In this scenario, the media playback system could comprise a first partition comprising playback device 205 and a second partition comprising playback device 206, both associated with the same location (LocA). In some instances, this mapping can be temporary and/or require confirmation from the user. In some instances, this scenario may characterize a potential system split where different playback devices are in different partitions and/or networks.

The computing system can then send configuration message 804 to the playback device 205 confirming the data and/or mapping. Additionally, the computing system could notify the media playback system (e.g., the control device) of any changes in location and/or mapping, as indicated in block 801. In this case, for example, the controller can be notified that there is some inconsistency with the mappings for locA that may require user attention. For example, the controller can be notified that there is a potential system split.

### c. Notify User

FIG. 9 includes a flowchart for a set of example methods of notifying a user and receiving user input, in accordance with embodiments described herein. The methods in FIG. 9 can be performed by any one or more suitable devices in the media playback system such as control device 401. Method 900 includes a block 902 of receiving an indication of a change in the locations data. The indication can be an indication that a location changed, and/or that there is conflicting/inconsistent data that needs user input for resolution. The indication can be the notification sent in blocks 724 in FIG. 7 and/or 801 in FIG. 8.

Method 900 also includes a block 904 of notifying the user. In some instances the user can be notified that there has been a change in the locations data. In some instances, the user can be notified of the specific change, for example that a new location has been created and/or associated with a playback device. In some instances, the user may be notified that there is a potential conflict in the system that needs user resolution. For example, the user may be notified that there are two partitions associated with the same location and prompted to confirm whether the split was intentional and/or whether a different location should be created/selected for the new partition.

The user can be notified in various ways. In some instances, the controller can display, based on the indication received in block 902, a graphical interface comprising an indication of the issue and/or update. Alternatively or in combination, the control device could provide some other kind of notification such as an audio or push notification. The notification could also be provided by any other devices in the media playback system such as any of the playback devices. For example, the playback devices can provide a visual feedback such as a change in a status light, provide an audio notification, etc. The notification could also be provided via any other suitable means such as e-mail, instant or text messages, etc.

### d. Receive Input

Method 900 includes a decision block 905 that can be decided via a user input. The input can be provided in various ways. For example, the user could select a selectable option in the graphical interface on the controller that indicates whether the split was intentional or not. As another example, the user could provide an input via a user interface of any of the devices in the media playback system, such as a button of one of the playback devices. As another example, the user could provide an input via a voice command. In any case, the input can indicate whether the split was intentional so that the system can be reconfigured accordingly.

### e. Associate With Different Location

In instances in which the input indicates that the split was intentional, method 900 can proceed to a process of creating a new location and/or select an existing one for the new partition (e.g., by performing one or more blocks of method 400 and/or 500). Alternatively, the computing system can create a location for the new partition, as described with reference to the example in FIG. 7. In some instances, after the split is resolved, any user interface showing the indication of the split (e.g., a display of the control device) can be updated to no longer show the indication regarding the split, as indicated by block 912.

### f. Forgo Split

In instances in which the input indicates that the split was not intentional, the system can ignore the split and/or forgo implementation of the split at a system level (e.g., forgo association of a different location to the new partition), as indicated by block 906. Method 900 can optionally proceed to guide the user to solve the networking issue, as indicated in block 907. For example, the control device could display instructions for the user to reset the device or reset their router. As another example, the control device could display instructions for the user to disconnect the playback device from the new network and connect it to the previous network or vice-versa. After the issue is solved (for example after the playback devices register with the computing system with non-conflicting location data), the user interface can be updated to no longer show the notification regarding the split. For example, the control device could receive an indication that the issue has been solved (e.g., that location data has changed) as indicated in block 908, and update the user interface based on that indication, as indicated in block 909.

### g. Implement Split Under Same Location

In some instances, the state in which there are more than one networks/partitions mapped to a same location can be a temporary state and/or a state that requires user resolution. In some instances, this state can be a non-ideal state or unreliable state in that certain functionalities may not work as expected in some situations. In those cases, the notification of the split could be permanently or periodically displayed/provided until the user solves the split (e.g., fixes the issue, confirms the split, etc.). In the meantime, the user could have limited functionalities for the system, etc. However, in some instances, having more than one network/partition under the same location is an acceptable and/or supported state that the user can configure as desired. In such case, the computing device could store a mapping and/or association between the two networks/partitions to the same location, and use this mapping for any further action in the system.

### Location Identifier Structure

In some instances, the location identifier is a Universally Unique Identifier (UUID) that can be generated by a UUID generator module. The UUID generator module could be implemented by a software module running in a computing device remote to the media playback system, such as any of the computing systems/devices described before in this disclosure. In those instances, an API could be used to trigger generation of the UUID. The UUID generator module can be implemented by a software module running in any of the devices of the media playback system, such as the control device. The UUID generation module could be any pseudo random number generator. In some instances, the UUID generation module can be a cryptographically strong pseudo random number generator.

In some instances, the location identifier can be a random or pseudo random and unique UUID. A location identifier could contain any number of characters (e.g., numbers, letters, symbols, etc.) and be of any size in bits. As a non-limiting and merely illustrative example, a location identifier could contain 36 characters, 280 bits, 35 bytes. Among those characters, certain symbols can be included, such as “-” to separate different sections, for example, “08ca523f-9d09-46ad-8edf-6ebee4254c39”. Any other alternatives are possible. For example, the symbols can be excluded. As another example, certain affixes could be added such as prefixes, suffixes and/or infixes. For example, the prefix “lc_” could be added a prefix.

In some instances, the location identifier can be created following certain rules. For example, for a location identifier of a certain size in bits, some bits can be for special purposes and others can be filled at random. For example, for a 128 bits location identifier, 6 bits could be reserved for special use (e.g., version, variant bits, etc.), and the remaining 122 bits can be filled at random. In some instances, because of its UUID nature, there is no need for a central authority to ensure uniqueness of the location identifier. Furthermore, UUIDs are easy to merge, in that different datasets merged as GUID entity identifiers are unlikely to collide.

### Registration Race

The examples described above with reference to FIG. 7 included two playback devices 205 and 206 sending registration requests at different times. In those scenarios, the computing system could be able to attend the requests for one playback device at a time. The computing system could use any data resulting from interactions with previous playback devices to fulfill any subsequent requests. For example, if a location (e.g., LocA) has already been created/assigned based on certain data and/or combination of data (e.g., a same user identifier, system identifier, partition identifier, and/or LAN identifier), the computing system can send/assign that same location data to any playback device registering with the same or similar data (such as in the example configuration messages 701 and 712 of FIG. 7, which first assign LocA to device 205 and subsequently to device 206 based on the corresponding “Data1” in the respective registration requests).

However, in some instances, two or more playback devices of the same system may attempt to register with the computing system at substantially the same time, which could trigger a “registration race” in that the two or more playback devices could be both “competing” for a location/location identifier. In some of those instances, the computing system could attend to the multiple requests at substantially the same time. The computing system may assign a different (e.g., random) location identifier to different playback devices because the computing system has no data (e.g., mappings) stored that indicate that the two playback devices are in the same partition and/or should be assigned to the same location.

In some instances, the computing system could employ mechanisms to ensure that both playback devices attempting to register from the same partition are assigned to the same location. For example, when the computing system receives multiple registration requests at the same time, or substantially at the same time, or otherwise while another registration request is still being processed/fulfilled, the computing system could implement a “hold” for the current or subsequent request. The hold can be implemented by waiting, when a registration request is received, for a period of time before processing the request (e.g., until one or more previous requests have finished processing). This strategy would buffer, delay and/or put one or more cloud registration requests on hold for a period of time. In this way, the computing system could finish fulfilling one request (e.g., looking for/generating location data, computing/generating/updating mappings, etc.) before processing and/or executing the other request.

### Media Playback System Topology and Location Data Mappings

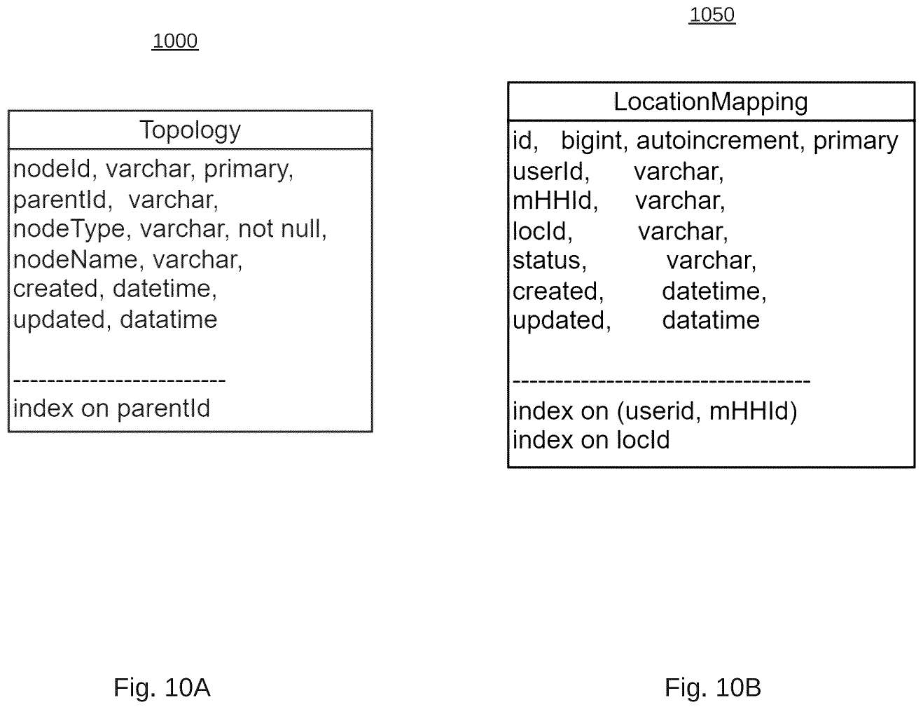

As described before in this disclosure, locations are part of the media playback system topology. The media playback system topology can be implemented as a data structure that can be stored in a storage of the computing system and/or any device of the media playback system. Such data structure can be then modified whenever there is a change in locations and/or any other change that affects the topology of a given system. FIG. 10A illustrates an example of a data structure in the form of a table 1000 that could be used to represent nodes in the topology.

In the example of FIG. 10A, the topology data structure comprises data that serves to identify the node in the topology, such as a nodeID (e.g., the location identifier), a node type (e.g., location), a node name (e.g., the location name), and any other data such as time stamps for when the entry was created and/or updated. The data structure could be indexed on any of the data it comprises and/or any other data. For example, the data structure could be indexed on a user identifier, system identifier, and/or any identifier (e.g., identifier of a parent node). This data structure can be dynamically updated when there are changes to the topology. For example, a new entry (e.g. row) can be created when a new location is created (e.g., in block 455A of FIG. 4). As another example, entries can be updated when there are changes/updates to the locations (e.g., in blocks 557 of FIG. 5, 653 of FIG. 6, 655C of FIG. 8) to reflect the change in attributes (e.g., if a network changed, if a new device was added to the location, etc.). The data structure can also comprise data identifying the level in the hierarchy of the topology that a certain node is at, for example by identifying a node type. By creating, updating, removing, and associating/indexing nodes of the topology as they are added, modified and/or removed, the topology data structure can then reflect the most current state of the system.

As also described before in this disclosure, location data could be stored in association with other data. The association could be in the form of one or more mappings. The mappings could also be a data structure stored in a storage of the computing system and/or any device of the media playback system. FIG. 10B illustrates an example of a data structure in the form of a table 1050 that could be used to represent a mapping. As illustrated, the mapping could include any kind of data associated with the location such as location identifier, user identifier, device identifier, partition/subsystem identifier, date created, date updated, etc. The mapping could also be indexed on any data, such as any of the data it comprises or other data. This data structure can be dynamically updated when there are changes to the system. For example, a new entry (e.g. row) can be created when a new mapping is created (e.g., in block 455B and 455C of FIG. 4). As another example, entries can be updated when there are changes/updates to the mappings (e.g., in blocks 557 of FIG. 5, 653 of FIG. 6, 655C of FIG. 8) to reflect the change in attributes (e.g., if a network changed, if a new device was added to the location, etc.). This data structure can be computed (e.g., via a lookup operation) to obtain data, for example during execution of blocks 655 of FIG. 6, 655A/655B of FIG. 7, 655A/655B of FIG. 8.

In some instances, the mapping could include data indicating a status of a given location. For example, when a location is created but has not yet any hardware (e.g., playback devices) assigned to it, the status could be “PROVISIONED”. When hardware is registered with the location, the status could be “REGISTERED”. If another partition is added to the mapping relationship (i.e., one location/location identifier has more than one partition assigned to it, the status could be “SPLIT”. In some instances, “SPLIT” could indicate that user resolution is required to solve the non 1:1 conflict manually.

In some instances, the topology data structure and any mapping(s) data structures could be implemented as a single data structure. For example, any data in the mapping could be included directly in the topology data structure. However, it could be advantageous to have separate data structures so that their individual size can be reduced and/or so that it is easier and/or faster to find data and compute mappings.

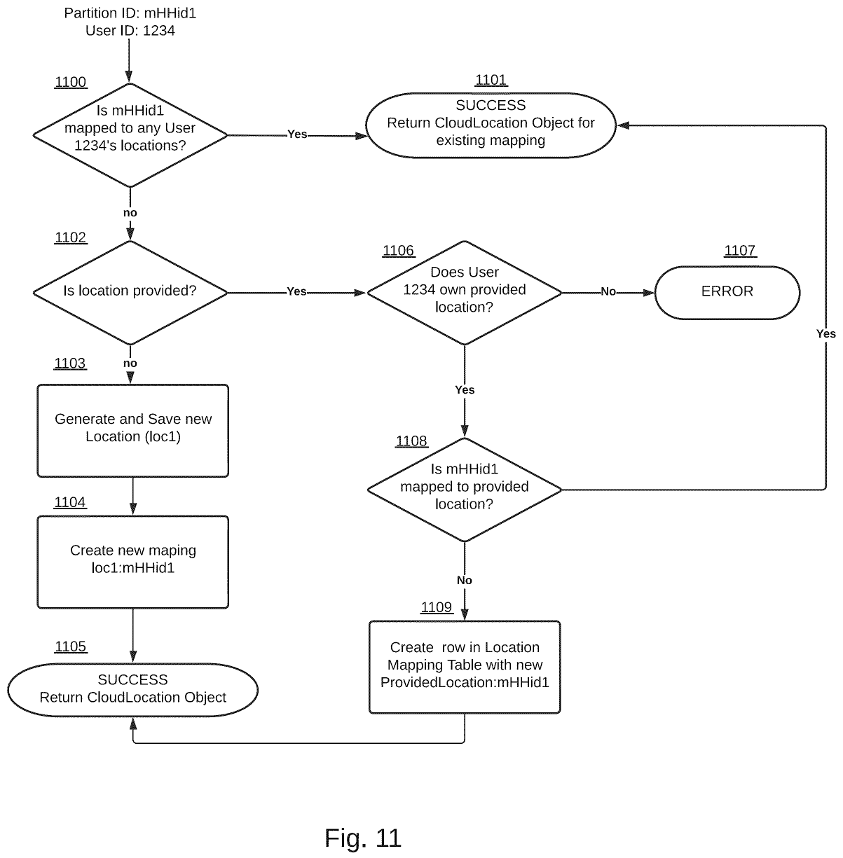

The examples illustrated in FIGS. 10A and 10B are illustrative examples of a very simple implementation. However, the topology and mappings could be more complex, comprise more data, more rows and/or related/indexed data structures. For example, every time a location is created, a new row could be added to the topology table for the new location. FIG. 11 includes an example flowchart illustrating example processes in which the topology table and/or any related mappings can be accessed/updated.

The flowchart in FIG. 11 starts with the computing system (or any device of the media playback system such as the control device), receiving, in one or more messages, data from a device of the media playback system. In the illustrated example, the data comprises a User ID: 1234 and a partition ID: mHHid1. The data could alternatively or in combination comprise a device ID, a system ID, a location ID, or any other data that the device is in possession of. The first decision block 1100 relates to a determination of whether the partition ID (or device ID or any other provided ID that serves this purpose) is mapped to any existing location belonging to user 1234. If the mapping exists, the flowchart goes to block 1101 of returning the location data (e.g., location object, location ID, etc.).

In instances in which the mapping does not exist, the flowchart goes to decision block 1102 of determining whether any location data was provided. If no location data was provided, the flowchart goes to block 1103 of generating a new location (Loc1 in this example) and to block 1104 of creating any related mapping such as a mapping that correlates the newly created location Loc1 with the partition/device identifier (mHHid1 in this example). At this point, a new row can be added to the topology table representing the newly created location. After this block, the flowchart goes to block 1105 of returning the location data. This process can happen in a similar way as described with reference to methods 400/450 in FIG. 4.

Referring back to decision block 1102, in instances in which location data was provided with the request, the flowchart goes to decision block 1106 of determining whether the user 1234 “owns” and/or is associated with the location provided with the request. This determination could include a lookup operation in the topology table and/or any existing mapping. If the user does not own the location (e.g., if no mapping exists between the user and the location), the flowchart continues to block 1107 of providing an error indication. If the user does own the location (e.g., if a mapping exists between the user and the location), then the flowchart goes to decision block 1108 of determining whether the partition/device identifier is already mapped to the location provided with the request. If the identifier is mapped to that location, the flowchart can go to block 1101 of providing the location object for the existing mapping.

If the mapping does not exist, flowchart can go to block 1109 of creating a new row in the location mapping table with the new data that maps the location provided with the request to the partition/device identifier also provided with the request. The location data can then be provided in block 1105.

### Location Groups

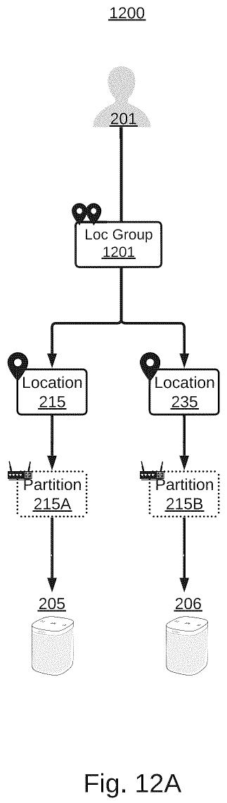

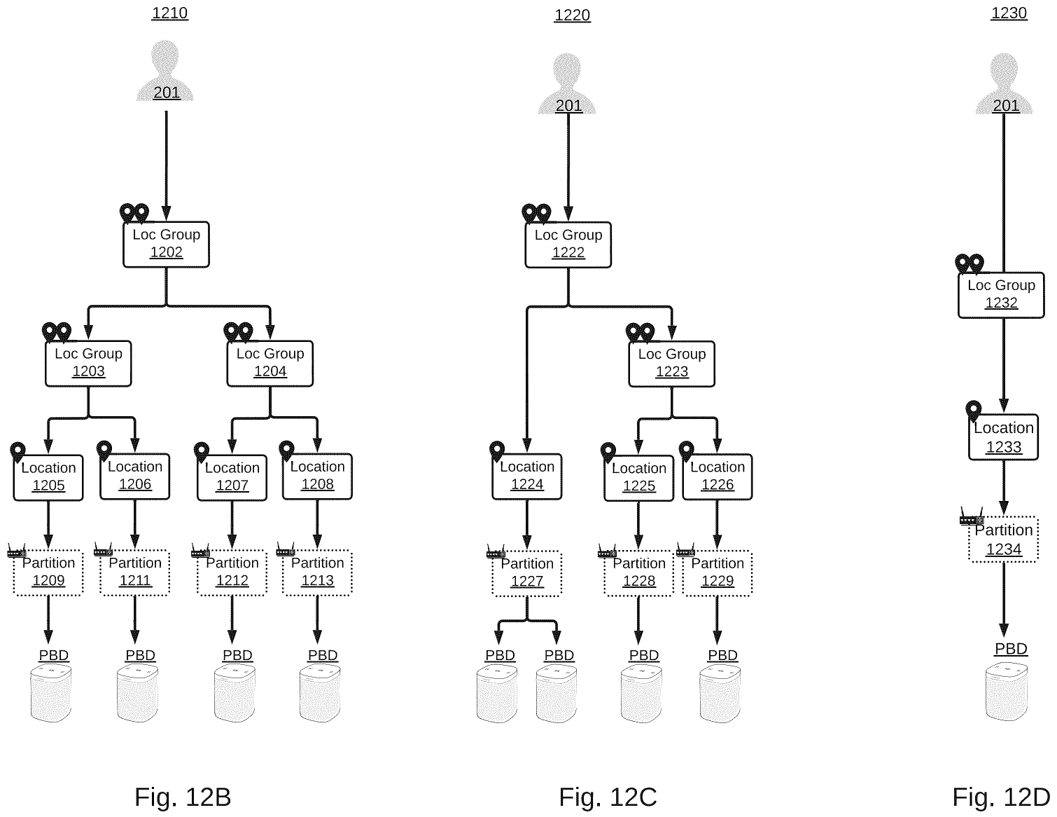

In some instances, the media playback system can comprise one or more groups of locations. FIG. 12A-12D illustrate example media playback systems topologies comprising one or more location groups (e.g., location group 1201 in FIG. 12A). As illustrated in FIG. 12A, locations 215 and 235, introduced with reference to FIG. 2, can be grouped under a location group 1201. In this way, any attributes of the location group 1201 could apply to locations 215 and 235, in a similar way as attributes of a locations apply to any playback device under the location.

Location groups can have a location group identifier. In this way, location groups can be addressable via the location group identifiers, in a similar way as explained for locations/location identifier. The location group identifier can be established (e.g., generated) in the same or similar way as the location identifier explained before in this disclosure (e.g., block 455A of method 450). In some instances, the location group can be a globally unique identifier. In some instances, the location group identifier can comprise (or be derived from) the location identifiers of any location under the location group. In some instances, the location group identifier can comprise (or be derived from) the partition identifiers of any partitions under the location group. In some instances, the location group identifier can comprise (or be derived from) the playback device identifiers of any playback devices under the location group.

In some instances, location groups and/or location group identifiers can be stable and/or permanent, as explained before for locations/location identifiers. In this way, location groups, once created, can persist as nodes in the system's topology unless modified (e.g., deleted) by a user. In this way, changes can occur in the lower levels of the topology's hierarchy without impacting the existence/function of the location group. For example, locations and/or playback devices can be removed from a location group while the location group continues to exist (so that locations and payback devices can still be added/mapped to it).

In a similar way as explained for locations and/or location identifiers, location groups and/or location group identifiers can have/be associated with a set of attributes. This set of attributes can then apply to any location under the location group. In this way, locations and/or playback devices can be added to the location group and obtain any attributes for the location group so that they are ready to operate as a member of the location group. Similarly, commands for the location group could apply to all the elements under the location group when appropriate.

Location groups can be created based on an input (e.g., a user input). For example, a user may be able to group location via a user interface of the media playback system (e.g., a display of a control device). Furthermore, location groups can be named and configured by the user, in a similar way as explained for locations.

In some instances, location groups can be created based on an event (e.g., a change in the system). The location group can be suggested to the user and/or created automatically by the system based on the event. For example, when locations are split (manually or automatically) into two or more locations, the system can generate a location group for the split locations so that they remain associated and can continue to be addressed collectively (e.g., until a user manually dissociates them). As mentioned before in this disclosure, in some instances locations and partitions exist in a one-to-one correspondence in the system. In these cases, when it is desired to have two or more partitions of a media playback system grouped together (e.g., to address them collectively), the system could associate each of the locations in a location group. In this way, when a user input is received to implement a split under a same location (e.g., block 314 of method 300 in FIG. 3), the system could automatically generate respective locations corresponding to each partition of the split and group them under a location group, rather than having two partitions under a same location.

As illustrated in additional examples in FIGS. 12B-12D, the media playback system topology can take any form and comprise any number of nodes and levels. As explained before, the media playback system can comprise any number of playback devices (PBDs), partitions and/or locations. Similarly, the media playback system can comprise any number of location groups, groups of location groups, etc. In some instances, the location groups can have other location groups, locations, playback devices and/or any combination thereof directly under the location group node. For example, diagram 1220 illustrates a location group 1222 comprising another location group 1223 and location 1224. Furthermore, location groups can exist even when only one or no location exists under the location groups. For example, diagram 1230 illustrates a location group 1232 comprising a single location 1233 in turn associated with a single partition 1234.

Location groups can be added to the topology data structure in the same way as locations and/or any other node. They can be identified by the location group identifier and a type of node “location group”. They can also be indexed by system, user, locations, playback devices, etc. Location groups can also be mapped to other nodes and resources in the same way as any other node.

Similarly to locations and location groups, other resources/nodes in the system can be grouped and/or form new nodes in the topology. For example, groups of playback devices in a particular partition or location could be represented by nodes under the partition or location in the topology. As another example, a zone of one or more playback devices could also be represented as a node in the topology. Each of these nodes can be associated with a node identifier and/or a set of attributes that would apply to the particular node and optionally to any node under the particular node, in the same or similar way as explained for locations and location groups. In this way, a playback device can be configured to operate in accordance with the attributes (e.g., settings, commands, permissions, entitlements, etc.) of any or all the nodes above it in the topology (e.g., the zone it belongs to, the location it belongs to, the group of locations it belongs to, etc.). In some instances, when the attributes overlap or conflict, the playback device can be configured to operate under the attributes of the node that is closest to it in the topology. For example, if a location is entitled to use two different media services (e.g., is subscribed to two different media services) but the zone the playback device is assigned to is configured to use only one of the two media services, the playback device can be configured to use the only one media service to which the zone is entitled. In other instances, when the attributes overlap or conflict, the playback device can be configured to operate under the most restrictive set of attributes. For example, if the location to which the playback device belongs has a maximum volume limit of 100% but the maximum volume limit for the location group comprising such location is changed to 50%, the playback device can be configured to operate with the most restrictive 50% volume limit. In this case, the locations (or any other node) under the location group could also be configured to operate with the new volume configuration. Other examples are possible.

The techniques described in this disclosure enable a more flexible and scalable media playback system operation. A media playback system capable of being structured by locations and location groups opens a window to a new set of possibilities for configuring and managing media playback systems. For example, configurations such as settings, preferences, services, permissions, entitlements, rules, etc. established for the media playback system can be established on a per-location basis so that each collection of playback devices under a location can fallow a set of configurations that differs from other playback devices in other locations of the same system. This can be particularly relevant for larger systems with more complex and dynamic topologies. Example of systems that could leverage this architecture are described in U.S. patent application Ser. No. 18/635,595, filed Apr. 15, 2024 and titled “MULTI-USER MEDIA PLAYBACK SYSTEM,” and U.S. patent application Ser. No. 18/635,943, filed Apr. 15, 2024 and titled “Media Playback System Switcher,” the contents of each of which are incorporated by reference in their entireties.

Locations can also be leveraged for other purposes such as for billing purposes or to manage subscriptions. For example, certain subscriptions could be provided on a per-location basis so that as the number of locations increases/decreases, the total price for the subscription can increase/decrease accordingly. Associating the subscription with the locations architecture described in this disclosure could enable automation of this process because the subscription could be updated automatically based on determining that a new location has been added to the system and/or that a location has been removed from the system. As another example, certain services such as streaming services could offer subscriptions for a certain number of locations. These services could benefit from the locations architecture in that they could be able to determine how many locations are using the service at a given time (e.g., to limit playback at any additional location simultaneously), and/or to determine whether there are more/less locations using the service (e.g., to adjust pricing accordingly). Other examples are possible.

In some embodiments, for example, a computing system is disclosed. The computing system comprises at least one processor and at least one non-transitory computer-readable medium comprising program instructions that are executable by the at least one processor such that the computing system is configured to: store an association between a media playback system and a first location identifier, wherein the media playback system comprises at least a first playback device and a second playback device connected to a first local area network; detect a split of the media playback system into a first partition comprising at least the first playback device connected to the first local area network and a second partition comprising at least the second playback device connected to a second local area network; cause the media playback system to provide an indication of the split via a user interface of the media playback system; and based on an input received via the user interface confirming the split, dissociate the second partition from the first location identifier and associate it with a second location identifier.

In some embodiments, for example, a non-transitory computer-readable medium is disclosed. The non-transitory computer-readable medium having stored thereon instructions executable by one or more processors to cause a computing system to perform functions comprising: storing an association between a media playback system and a first location identifier, wherein the media playback system comprises at least a first playback device and a second playback device connected to a first local area network; detecting a split of the media playback system into a first partition comprising at least the first playback device connected to the first local area network and a second partition comprising at least the second playback device connected to a second local area network; causing the media playback system to provide an indication of the split via a user interface of the media playback system; and based on an input received via the user interface confirming the split, dissociating the second partition from the first location identifier and associating it with a second location identifier.

In some embodiments, for example, a method to be performed by a computing system is disclosed. The method comprising storing an association between a media playback system and a first location identifier, wherein the media playback system comprises at least a first playback device and a second playback device connected to a first local area network; detecting a split of the media playback system into a first partition comprising at least the first playback device connected to the first local area network and a second partition comprising at least the second playback device connected to a second local area network; causing the media playback system to provide an indication of the split via a user interface of the media playback system; and based on an input received via the user interface confirming the split, dissociating the second partition from the first location identifier and associating it with a second location identifier.

In some embodiments, the first partition is associated with a first set of attributes; the second partition is associated with a second set of attributes; and the first set of attributes and the second set of attributes comprise at least one common attribute which is common to both sets of attributes and at least one different attribute which is different for each set of attributes. In some embodiments, the at least one common attribute comprises one or more of: a user identifier or a system identifier; and the at least one different attribute comprises one or more of: a partition identifier, a device identifier, or a network identifier.

In some embodiments, the association between the media payback system and the first location identifier comprises a mapping of the first location identifier to at least one characteristic of the media playback system. In some embodiments, the at least one characteristic comprises a media playback system identifier. In some embodiments, the at least one characteristic comprises a first device identifier of the first playback device and a second device identifier of the second playback device. In some embodiments, the at least one characteristic comprises a characteristic corresponding to a corresponding local area network to which the first playback device and the second playback device are connected.

In some embodiments, detecting the split comprises determining that the second playback device is connected to the second local area network which is different from the first local area network. In some embodiments, determining that the second playback device is connected to the second local area network comprises receiving, from the second playback device, data identifying the second local area network.

In some embodiments, associating the second partition with the second location identifier comprises: generating the second location identifier; and storing a mapping of the second location identifier to at least one characteristic of the second partition. In some embodiments, the at least one characteristic of the second partition comprises a partition identifier of the second partition.

### IV. CONCLUSION

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
store an association between a media playback system and a first location identifier, wherein the media playback system comprises at least a first playback device and a second playback device connected to a first local area network;
detect a split of the media playback system into a first partition comprising at least the first playback device connected to the first local area network and a second partition comprising at least the second playback device connected to a second local area network;
cause the media playback system to provide an indication of the split via a user interface of the media playback system; and
based on an input received via the user interface confirming the split, dissociate the second partition from the first location identifier and associate it with a second location identifier.

2. The computing system of claim 1 wherein:
the first partition is associated with a first set of attributes;
the second partition is associated with a second set of attributes; and
the first set of attributes and the second set of attributes comprise at least one common attribute which is common to both sets of attributes and at least one different attribute which is different for each set of attributes.

3. The computing system of claim 2, wherein:
the at least one common attribute comprises one or more of: a user identifier or a system identifier; and
the at least one different attribute comprises one or more of: a partition identifier, a device identifier, or a network identifier.

4. The computing system of claim 1, wherein the association between the media playback system and the first location identifier comprises a mapping of the first location identifier to at least one characteristic of the media playback system.

5. The computing system of claim 4, wherein the at least one characteristic comprises a media playback system identifier.

6. The computing system of claim 4, wherein the at least one characteristic comprises a first device identifier of the first playback device and a second device identifier of the second playback device.

7. The computing system of claim 4, wherein the at least one characteristic comprises a characteristic corresponding to a corresponding local area network to which the first playback device and the second playback device are connected.

8. The computing system of claim 1, wherein detecting the split comprises determining that the second playback device is connected to the second local area network which is different from the first local area network.

9. The computing system of claim 8, wherein determining that the second playback device is connected to the second local area network comprises receiving, from the second playback device, data identifying the second local area network.

10. The computing system of claim 1, wherein associating the second partition with the second location identifier comprises:
generating the second location identifier; and
storing a mapping of the second location identifier to at least one characteristic of the second partition.

11. The computing system of claim 10, wherein at least one characteristic of the second partition comprises a partition identifier of the second partition.

12. A non-transitory computer-readable medium having stored thereon instructions executable by one or more processors to cause a computing system to perform functions comprising:
storing an association between a media playback system and a first location identifier, wherein the media playback system comprises at least a first playback device and a second playback device connected to a first local area network;
detecting a split of the media playback system into a first partition comprising at least the first playback device connected to the first local area network and a second partition comprising at least the second playback device connected to a second local area network;
causing the media playback system to provide an indication of the split via a user interface of the media playback system; and
based on an input received via the user interface confirming the split, dissociating the second partition from the first location identifier and associating it with a second location identifier.

13. The non-transitory computer-readable medium of claim 12, wherein:
the first partition is associated with a first set of attributes;
the second partition is associated with a second set of attributes; and
the first set of attributes and the second set of attributes comprise at least one common attribute which is common to both sets of attributes and at least one different attribute which is different for each set of attributes.

14. The non-transitory computer-readable medium of claim 13, wherein:
the at least one common attribute comprises one or more of: a user identifier or a system identifier; and
the at least one different attribute comprises one or more of: a partition identifier, a device identifier, or a network identifier.

15. The non-transitory computer-readable medium of claim 12, wherein the association between the media playback system and the first location identifier comprises a mapping of the first location identifier to at least one characteristic of the media playback system.

16. The non-transitory computer-readable medium of claim 15, wherein the at least one characteristic comprises a media playback system identifier.

17. The non-transitory computer-readable medium of claim 15, wherein the at least one characteristic comprises a first device identifier of the first playback device and a second device identifier of the second playback device.

18. The non-transitory computer-readable medium of claim 15, wherein the at least one characteristic comprises a characteristic corresponding to a corresponding local area network to which the first playback device and the second playback device are connected.

19. The non-transitory computer-readable medium of claim 15, wherein detecting the split comprises determining that the second playback device is connected to the second local area network which is different from the first local area network.

20. A method to be performed by a computing system, the method comprising:
storing an association between a media playback system and a first location identifier, wherein the media playback system comprises at least a first playback device and a second playback device connected to a first local area network;
detecting a split of the media playback system into a first partition comprising at least the first playback device connected to the first local area network and a second partition comprising at least the second playback device connected to a second local area network;
causing the media playback system to provide an indication of the split via a user interface of the media playback system; and
based on an input received via the user interface confirming the split, dissociating the second partition from the first location identifier and associating it with a second location identifier.
